(19) United States
(12) Patent Application Publication
(10) Pub. No.: US 2014/0200326 A1
(43) Pub. Date: Jul. 17, 2014

(54) POLYMER PRODUCT, POLYMER COMPACT, POLYMER COMPACT FOR MEDICAL USE, TONER, AND POLYMER COMPOSITION

(71) Applicant: Ricoh Company, Ltd, Ohta-ku, Tokyo (JP)

(72) Inventors: Yoshitaka Yamauchi, Shizuoka (JP); Chiaki Tanaka, Shizuoka (JP); Taichi Nemoto, Shizuoka (JP); Kazumi Suzuki, Shizuoka (JP); Keiko Osaka, Shizuoka (JP); Shinichi Wakamatsu, Shizuoka (JP); Satomi Sabu, Shizuoka (JP)

(21) Appl. No.: 14/238,330

(22) PCT Filed: Aug. 6, 2012
(86) PCT No.: PCT/JP2012/070579

§ 371 Date: Feb. 11, 2014

(30) Foreign Application Priority Data
Aug. 12, 2011 (JP) 2011-176717
Aug. 12, 2011 (JP) 2011-176724
Aug. 12, 2011 (JP) 2011-176731
Aug. 12, 2011 (JP) 2011-176735
Aug. 12, 2011 (JP) 2011-176743
Mar. 21, 2012 (JP) 2012-063553

(51) Int. Cl. G03G 9/087; C08G 64/02; C08G 63/08

(52) U.S. Cl. CPC G03G 9/08757; C08G 63/08; C08G 64/0208; G03G 9/08755
USPC 528/355; 528/371

(57) ABSTRACT

To provide a polymer product, which is substantially free from an organic solvent and a metal atom, and has a number average molecular weight of 12,000 or greater.

### TECHNICAL FIELD

The present invention relates to a polymer product, a polymer compact, a polymer compact for medical use, a toner, and a polymer composition.

### BACKGROUND ART

Conventionally, various polymers have been produced by polymerizing ring-opening polymerizable monomer through ring-opening polymerization. For example, polylactic acid is produced by ring-opening polymerization of lactide, as one example of the ring-opening polymerizable monomers. The produced lactic acid is utilized as fibers for suture threads, sheets for biocompatible materials, particles for cosmetic products, or films for plastic bags.

As for a method for producing a polymer through ring-opening polymerization of a ring-opening polymerizable monomer, known is a method for reacting a ring-opening polymerizable monomer in a melted state. For example, as a method for producing polylactic acid through ring-opening polymerization of lactide, there is a known method in which tin octylate is used as a catalyst, reaction temperature is set to 195° C., and lactide is allowed react in a melted state to undergo polymerization (see PTL 1). In the case where polylactic acid is produced by this production method, however, more than 2% by mass of lactide residues remain in a product (see PTL 1). The residues remain because an equilibrium relationship between a ring-opening polymerizable and a polymer is established in a reaction system of ring polymerization, such as of lactide, and a ring-opening polymerizable monomer tends to generate as a result of a depolymerization reaction, in the case where ring-opening polymerization of a ring-opening polymerizable monomer is carried out at high temperature such as the aforementioned reaction temperature. The lactide (ring-opening polymerizable monomer) residues may act as a hydrolysis catalyst on a generated product, or may reduce heat resistance of resulting polylactic acid. It has been known that lactic is reduced by performing a treatment where melting polylactic acid is exposed to a vacuumed atmosphere (see PTL 2), but the polylactic acid may be colored as it is kept in the melted state. Moreover, use of a hydrolysis decomposition inhibitor has been known (see PTL 3), but a resulting polymer product may decrease its mold processability, and physical properties of an obtained polymer compact may be degraded.

As for a method for polymerizing a ring-opening polymerizable monomer through ring-opening polymerization at low temperature, there is disclosed a method for performing ring-opening polymerization of lactide in an organic solvent (see PTL 4). In accordance with the disclosed method, poly-D-lactic acid is obtained at a monomer polymerization rate of 99.4% by polymerizing D-lactide in a dichloromethane solution at 25° C. When polymerization is carried out using an organic solvent, however, it is necessary to provide a process for dying the organic solvent to make a polymer ready for use. Moreover, it is still difficult to completely remove the organic solvent from the polymer product even with the drying process.

As for a method for polymerizing a ring-opening polymerizable monomer through ring-opening polymerization without an organic solvent, there is disclosed a method in which ring-opening polymerization of L-lactide is carried out in supercritical carbon dioxide using a metal catalyst (see NPL 1). In accordance with the disclosed method, particles of polylactic acid are obtained by polymerizing 10 w/v % of l-lactide relative to the supercritical carbon dioxide for 47 hours in the presence of tin octylate as a metal catalyst, at the reaction temperature of 80° C., and pressure of 207 bar. When polylactic acid is produced by this production method, however, there is a problem that tin octylate serving as the metal catalyst remains in a generated product. This problem occurs because the catalyst contains a metal atom and therefore it is not easily removed from a generated product. The tin octylate residues decrease heat resistance and safety of a generated product.

Disclosed is a method in which a catalyst free from a metal atom is used in ring-opening polymerization of lactide with supercritical carbon dioxide (see NPL 2). In accordance with the disclosed method, lactide is polymerized in a manner that an autoclave is charged with lactide, and 1,8-diazabicyclo[5.4.0]undec-7-ene (DBU) serving as an organic catalyst, the mixture is subsequently mixed, and carbon dioxide is introduced to turn the pressure to 250 atm. In accordance with this method, a polymer having a number average molecular weight of about 10,000 is obtained by reacting for 16 hours (see NPL 2).

However, a polymer product having a high molecular weight has not bee able to attain even by continuing a reaction for a ling period, when a metal atom-free organic catalyst is used as a catalyst in a method of ring-opening polymerization of a ring-opening polymerizable monomer using a compressive fluid such as supercritical carbon dioxide. Accordingly, there has been a problem that a resulting polymer product has low durability and softening point because of its low molecular weight.

### CITATION LIST

### Patent Literature

PTL 1: Japanese Patent Application Laid-Open (JP-A) No. 08-259676

PTL 2: JP-A No. 2008-63420

PTL 3: JP-A No. 2005-60474

PTL 4: JP-A No. 2009-1614

### Non-Patent Literature

NPL 1: Ganapathy, H. S.; Hwang, H. S.; Jeong, Y. T.; LEE, W-T.; Lim, K. T. Eur Polym J. 2007, 43(1), 119-126.

NPL 2: Idriss Blakey, Anguang Yu, Steven M. Howdle, Andrew K. Whittakera and Kristofer J. Thurechta, Green Chemistry, 2011, Advance Article

NPL 3: “The Latest Applied Technology of Supercritical Fluid (CHO RINKAI RYUTAI NO SAISHIN OUYOU GIJUTSU),” p. 173, published by NTS Inc. on Mar. 15, 2004

### SUMMARY OF INVENTION

### Technical Problem

The present invention aims to provide a polymer product capable of inhibiting reduction in durability and softening temperature of the polymer product influenced by a low molecular component.

### Solution to Problem

The polymer product of the present invention, which is the means for solving the aforementioned problems, is substantially free from an organic solvent and a metal atom, and has a number average molecular weight of 12,000 or greater.

### Advantageous Effects of Invention

The present invention can solve the aforementioned various problems in the art, achieves the aforementioned object, and provide a polymer product capable of inhibiting reduction in durability and softening temperature of the polymer product influenced by a low molecular component.

### BRIEF DESCRIPTION OF DRAWINGS

FIG. 1 is a general phase diagram depicting the state of a substance depending on pressure and temperature conditions.

FIG. 2 is a phase diagram which defines a compressive fluid used in the present invention.

FIG. 3 is a system diagram illustrating one example of a polymerization process of a continuous system.

FIG. 4 is a system diagram illustrating one example of the polymerization process of a batch system.

FIG. 5 is a system diagram illustrating one example of the polymerization process of a batch system.

### DESCRIPTION OF EMBODIMENTS

### (Polymer Product)

The polymer product of the present invention is substantially free from an organic solvent and a metal atom, and has a number average molecular weight of 12,000 or greater.

The polymer product is obtained through ring-opening polymerization of the ring-opening polymerizable monomer using a compressive fluid, and an organic catalyst free from a metal atom.

Raw materials used for formation of the polymer product, such as a ring-opening polymerizable monomer, will be explained next. In the present specification, the raw materials means materials used for forming a polymer, and materials that will be components of a polymer. The raw materials contain at least a ring-opening polymerizable monomer, and may further contain appropriately selected other components, such as an initiator, and additives.

### <Organic Catalyst>

The organic catalyst is appropriately selected depending on the intended purpose without any limitation, but it does not contain a metal atom to secure safety and stability of a product. In the present embodiment, the organic catalyst may be any organic catalyst, provided that it contributes to a ring-opening polymerization reaction of a ring-opening polymerizable monomer to form an active intermediate product with the ring-opening polymerizable monomer, and then it ca be removed and regenerated through a reaction with alcohol.

When a ring-opening polymerizable monomer containing an ester bond is polymerized, for example, the organic catalyst is preferably a (nucleophilic) compound having basicity and serving as a nucleophilic agent, more preferably a compound containing a nitrogen atom, and even more preferably a cyclic compound containing a nitrogen atom. Such a compound is appropriately selected depending on the intended purpose without any limitation, and examples thereof include cyclic monoamine, cyclic diamine (a cyclic diamine compound having an amidine skeleton), a cyclic triamine compound having a guanidine skeleton, a heterocyclic aromatic organic compound containing a nitrogen atom, and N-heterocyclic carbene. A cationic organic catalyst can be used for the aforementioned ring-opening polymerization reaction, but the cationic organic catalyst pulls hydrogen atoms out of the polymer backbone (back-biting). As a result, a resulting polymer tends to have a wide molecular weight distribution, and it is difficult to obtain a high molecular weight polymer.

Examples of the cyclic monoamine include quinuclidine. Examples of the cyclic diamine include 1,4-diazabicyclo-[2.2.2]octane (DABCO), and 1,5-diazabicyclo(4,3,0)-5-nonene. Examples of the cyclic diamine compound having an amidine skelton include 1,8-diazabicyclo[5.4.0]undec-7-ene (DBU), and diazabicyclononene. Examples of the cyclic triamine compound having a guanidine skeleton include 1,5,7-triazabicyclo[4.4.0]dec-5-ene (TBD), and diphenyl guanidine (DPG).

Examples of the heterocyclic aromatic organic compound containing a nitrogen atom include N,N-dimethyl-4-aminopyridine (DMAP), 4-pyrrolidinopyridine (PPY), pyrrocolin, imidazol, pyrimidine and purine. Examples of the N-heterocyclic carbine include 1,3-di-tert-butylimidazol-2-ylidene (ITBU). Among them, DABCO, DBU, DPG, TBD, DMAP, PPY, and ITBU are preferable, as they have high nucleophilicity without being greatly affected by steric hindrance, or they have such boiling points that they can removed under the reduced pressure.

Among these organic catalysts, for example, DBU is liquid at room temperature, and has a boiling point. In the case where such organic catalyst is selected for use, the organic catalyst can be removed substantially quantitatively from the obtained polymer by treating the polymer under the reduced pressure. Note that, the type of the organic solvent, or whether or not a removal treatment is performed, is determined depending on an intended use of a polymer product.

A type and an amount of the organic catalyst for use cannot be collectively determined as they vary depending on a combination of the compressive fluid, and ring-opening polymerizable monomer, which will be described later, but the amount thereof is preferably 0.01 mol % to 15 mol %, more preferably 0.1 mol % to 1 mol %, and even more preferably 0.3 mol % to 0.5 mol %, relative to 100 mol % of the ring-opening polymerizable monomer. When the amount thereof is smaller than 0.01 mol %, the organic catalyst is deactivated before completion of the polymerization reaction, and as a result a polymer having a target molecular weight cannot be obtained in some cases. When the amount thereof is greater than 15 mol %, it may be difficult to control the polymerization reaction.

### <Ring-Opening Polymerizable Monomer>

The ring-opening polymerizable monomer is preferably a ring-opening polymerizable monomer having a ring structure containing a carbonyl skeleton, such as an ester bond, though it depends on a combination of the ring-opening polymerizable monomer and compressive fluid for use. The carbonyl skeleton is formed with oxygen, which has high electronegativity, and carbon bonded together to form a π-bond. Because of electrons of the π-bond, oxygen is negatively polarized, and carbon is positively polarized, and therefore reactivity is enhanced. In the case where the compressive fluid is carbon dioxide, it is assumed that affinity between carbon dioxide and a generated polymer is high, as the carbonyl skeleton is similar to the structure of carbon dioxide. As a result of these functions, a plasticizing effect of the generated polymer using the compressive fluid is enhanced. Examples of such a ring-opening polymerizable monomer include cyclic ester, and cyclic carbonate. Use of the ring-opening polymerizable monomer results in formation of a polymer product, which is, for example, polyester or polycarbonate having a carbonyl skeleton, such as an ester bond or a carbonate bond.

The cyclic ester is not particularly limited, but it is preferably a cyclic dimer obtained through dehydration-concentration of an L-form or D-form of a compound represented by the following general formula 1.

R—C*—H(—OH)(—COOH) General Formula 1

In the general formula 1, R is a C1-C10 alkyl group, and C* represents an asymmetric carbon.

Examples of the compound represented by the general formula 1 include enantiomers of lactic acid, enantiomers of 2-hydroxybutanoic acid, enantiomers of 2-hydroxypentanoic acid, enantiomers of 2-hydroxyhexanoic acid, enantiomers of 2-hydroxyheptanoic acid, enantiomers of 2-hydroxyoctanoic acid, enantiomers of 2-hydroxynonanoic acid, enantiomers of 2-hydroxydecanoic acid, enantiomers of 2-hydroxyundecanoic acid, and enantiomers of 2-hydroxydodecanoic acid. Among them, enantiomers of lactic acid are preferable since they are highly reactive and readily available. These cyclic dimers may be used independently or in combination.

The usable cyclic ester other than the compound represented by the general formula 1 include, for example, aliphatic lactone, such as β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, glycolide and lactide. These may be used independently or in combination. Among them, ε-caprolactone is preferable since it is highly reactive and readily available.

The cyclic carbonate is appropriately selected depending on the intended purpose without any limitation, and examples thereof include ethylene carbonate, and propylene carbonate. These may be used independently or in combination.

### <Initiator>

In the present embodiment, a ring-opening polymerization initiator (initiator) can be used for controlling a molecular weight of a polymer to be formed. The initiator can be selected from conventional initiators known in the art. As long as the initiator is alcohol base, it may be, for example, mono-, di-, or polyhydric alcohol of aliphatic alcohol. The initiator may be saturated or unsaturated. Examples of the initiator include: monoalcohol such as methanol, ethanol, propanol, butanol, pentanol, hexanol, heptanol, nonanol, decanol, lauryl alcohol, myristyl alcohol, cetyl alcohol, and stearyl alcohol; dialcohol such as ethylene glycol, 1,2-propanediol, 1,3-propanediol, 1,3-butanediol, 1,4-butanediol, hexanediol, nonanediol, tetramethylene glycol, and polyethylene glycol; polyhydric alcohol such as glycerol, sorbitol, xylitol, ribitol, erythritol, and triethanol amine; and others such as methyl lactate, and ethyl lactate. These may be used independently or in combination.

Also, a polymer in which an alcohol residue is present at a terminal of polycaprolactonediol or polytetramethylene glycol may be used as the initiator. A use of such polymer enables synthesis of diblock copolymers and triblock compolymers.

An amount of the initiator is appropriately adjusted depending on a target molecular weight, but it is preferably 0.1 mol % to 5 mol % relative to 100 mol % of the ring-opening polymerizable monomer. In order to prevent polymerization from being initiated unevenly, the initiator is ideally sufficiently mixed with the ring-opening polymerizable monomer before the ring-opening polymerizable monomer is brought into contact with a polymerization catalyst.

### <Additives>

Additives may optionally be added for ring-opening polymerization. Examples of the additives include a surfactant, an antioxidant, a stabilizer, an UV-ray absorber, a pigment, a colorant, inorganic particles, various fillers, a mold-releasing agent, a plasticizer, and other similar additives. If necessary, a polymerization terminator (e.g., benzoic acid, hydrochloric acid, phosphoric acid, metaphosphoric acid, acetic acid and lactic acid) may be used after completion of polymerization reaction.

The surfactant is preferably selected from those dissolved in the compressive fluid and having compatibility to both the compressive fluid and the ring-opening polymerizable monomer. A use of the surfactant can give effects that the polymerization reaction can be uniformly progressed, and the resultant polymer has a narrow molecular weight distribution and be easily produced as particles. In the case where such surfactant is used, the surfactant may be added to the compressive fluid, or may be added to the ring-opening polymerizable monomer.

### <Compressive Fluid>

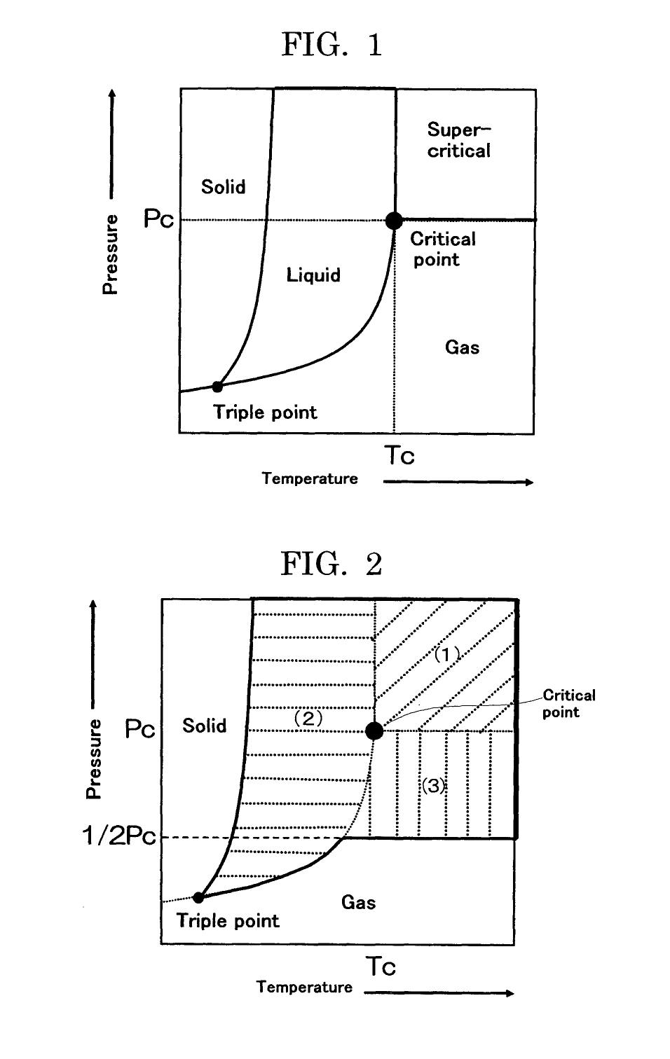

A compressive fluid for use in the production of a polymer product of the present embodiment will be explained with reference to FIGS. 1 and 2. FIG. 1 is a general phase diagram depicting the state of a substance depending on pressure and temperature conditions. FIG. 2 is a phase diagram which defines a compressive fluid used in the present embodiment. In the present embodiment, the term “compressive fluid” refers to a state of a substance present in any one of the regions (1), (2) and (3) of FIG. 2 in the phase diagram of FIG. 1.

In such regions, the substance is known to have extremely high density and show different behaviors from those shown at normal temperature and normal pressure. Note that, a substance is a supercritical fluid when it is present in the region (1). The supercritical fluid is a fluid that exists as a noncondensable high-density fluid at temperature and pressure exceeding the corresponding critical points, which are limiting points at which a gas and a liquid can coexist. When a substance is in the region (2), the substance is a liquid, but in the present embodiment, it is a liquefied gas obtained by compressing a substance existing as a gas at normal temperature (25° C.) and normal pressure (1 atm). When a substance is in the region (3), the substance is in the state of a gas, but in the present invention, it is a high-pressure gas whose pressure is ½ or higher than the critical pressure (Pc), i.e. ½Pc or higher.

Examples of a substance that can be used in the state of the compressive fluid include carbon monoxide, carbon dioxide, dinitrogen oxide, nitrogen, methane, ethane, propane, 2,3-dimethylbutane, and ethylene. Among them, carbon dioxide is preferable because the critical pressure and critical temperature of carbon dioxide are respectively about 7.4 MPa, and about 31° C., and thus a supercritical state of carbon dioxide is easily formed. In addition, carbon dioxide is non-flammable, and therefore it is easily handled. These compressive fluids may be used independently, or in combination.

In the case where supercritical carbon dioxide is used as a solvent, it has been conventionally considered that carbon dioxide is not suitable for living anionic polymerization, as it may react with basic and nucleophilic substances (see “The Latest Applied Technology of Supercritical Fluid (CHO RINKAI RYUTAI NO SAISHIN OUYOU GIJUTSU),” p. 173, published by NTS Inc. on Mar. 15, 2004). The present inventors have found that, overturning the conventional insight, a polymerization reaction progresses quantitatively by stably coordinating a basic and nucleophilic organic catalyst with a ring-opening monomer to open the ring structure thereof, and as a result, the polymerization reaction progresses livingly. In the present specification, the term “living” means that the reaction progresses quantitatively without a side reaction such as a transfer reaction or termination reaction, so that a molecular weight distribution of an obtained polymer is relatively narrow compared to that of the polymer obtained by melt polymerization, and is monodispersible.

### <<Polymerization Reaction Device>>

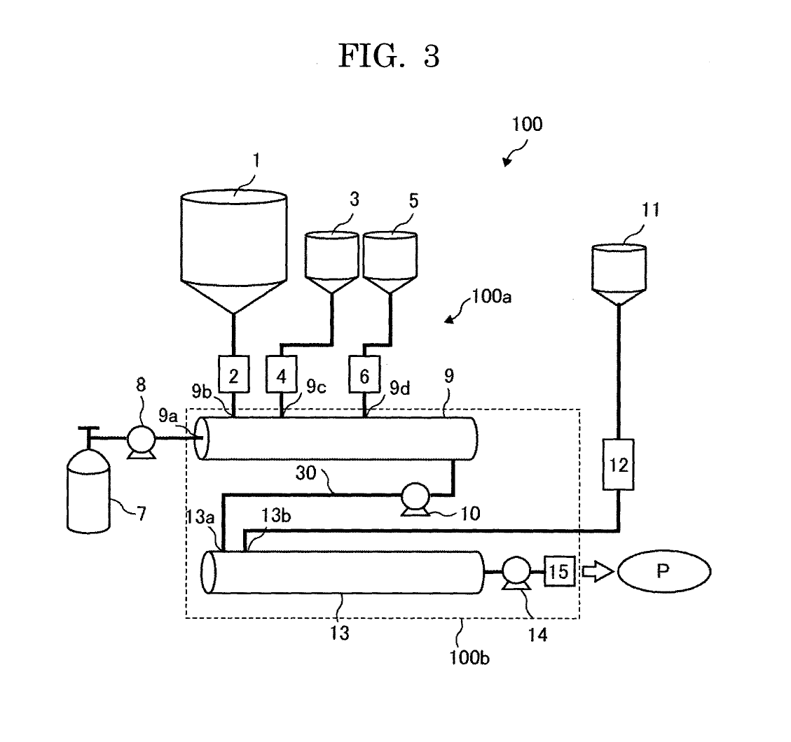

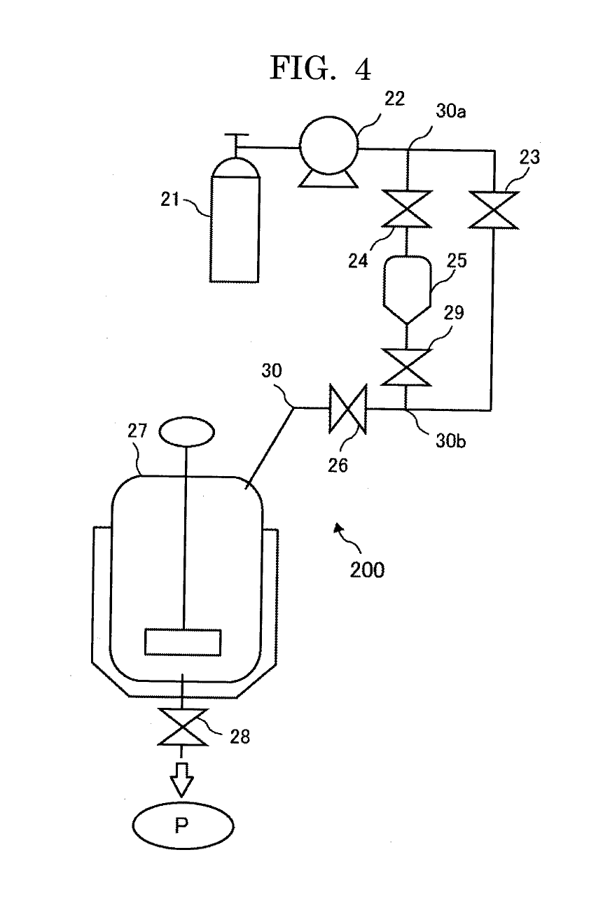

A polymerization reaction device used in the present embodiment for production of a polymer will be explained with reference to FIGS. 3 and 4, next. FIGS. 3 and 4 are system diagrams illustrating examples of a polymerization process.

First, the polymerization reaction device 100 will be explained with reference to FIG. 3. The polymerization reaction device 100 contains a supply unit 100a for supplying a raw material (e.g., a ring-opening polymerizable monomer) and a compressive fluid, and a main body 100b of the polymerization reaction device, which is one example of a continuous polymerization device for polymerizing the ring-opening polymerization monomer supplied from the supply unit 100a. The supply unit 100a contains tanks (1, 3, 5, 7, 11), metering feeders (2, 4), and metering pumps (6, 8, 12). The main body 100b of the polymerization reaction device contains a blending device 9 disposed at one end of the main body 100b of the polymerization reaction device, a liquid transfer pump 10, a reaction vessel 13, a metering pump 14, and a discharge nozzle 15 disposed at the other end of the main body 100b of the polymerization reaction device. Note that, in the present embodiment, a device for mixing a compressive fluid with a raw material or a polymer to dissolve or melt the raw material or the like is called a “blending device.” In the present embodiment, the term “melt” means that raw materials or a generated polymer is plasticized or liquidized with swelling as a result of the contact between the raw materials or generated polymer, and the compressive fluid. Moreover, the term “dissolve” means that the raw materials are dissolved in the compressive fluid.

The tank 1 of the supply unit 100a stores the ring-opening polymerizable monomer. The ring-opening polymerizable monomer for storing may be in a powderous state or liquid state. The tank 3 stores solids (powder or particles) among the materials used as an initiator and additives. The tank 5 stores liquids among the materials used as the initiator and additives. The tank 7 stores the compressive fluid. Note that, the tank 7 may store gas or a solid that is transformed into a compressive fluid upon application of heat or pressure during the process for supplying to the blending device 9, or within the blending device 9. In this case, the gas or solid stored in the tank 7 is transformed in the state of (1), (2), or (3) of FIG. 2 in the blending device 9 upon application of heat or pressure.

The metering feeder 2 measures the ring-opening polymerizable monomer stored in the tank 1, and continuously supplies the measured ring-opening polymerizable monomer to the blending device 9. The metering feeder 4 measures the solids stored in the tank 3 and continuously supplies the measured solids to the blending device 9. The metering pump 6 measures the liquids stored in the tank 5, and continuously supplies the measured liquids to the blending device 9. The metering pump 8 continuously supplies the compressive fluid stored in the tank 7 to the blending device 9 at constant pressure with a constant flow rate. Note that, in the present embodiment, the phrase “continuously supply” is used as a concept in reverse to a supply per batch, and means to supply in a manner that a polymer as a product of ring-opening polymerization is continuously obtained. Specifically, each material may be intermittently supplied as long as a polymer product of ring-opening polymerization is continuously obtained. In the case where the materials used as the initiator and additives are all solids, the polymerization reaction device 100 may not have the tank 5 and the metering pump 6. Similarly, in the case where the materials used as the initiator and additives are all liquids, the polymerization reaction device 100 may not have the tank 3 and the metering feeder 4.

In the present embodiment, each device in the main body 100b of the polymerization reaction device is connected with a pressure resistant pipe 30 for transporting the raw materials, compressive fluid, or generated polymer, as illustrated in FIG. 3. Moreover, each of the blending device 9, liquid transfer pump 10, and reaction vessel 13 of the polymerization reaction device has a pipe-shaped member for passing the aforementioned raw materials through.

The main body 100b of the polymerization reaction device of the blending device 9 is a device containing a pressure resistant container, and configured to continuously make the raw materials (e.g., the ring-opening polymerizable monomer, initiator, and additives) supplied from each tank (1, 3, 5) into contact with the compressive fluid supplied from the tank 7 to dissolve the raw materials. In the blending device 9, the raw materials are melted or dissolved by bringing the raw materials and the compressive fluid into contact with each other. When the ring-opening polymerizable monomer is dissolved, a fluid phase is formed. When the ring-opening polymerizable monomer is melted, a molten phase is formed. It is however preferred that a molten phase or fluid phase be formed with one layer in order to uniformly carry out a reaction. Moreover, it is preferred that the ring-opening polymerizable monomer be melted in order to carry out a reaction with a high ratio of the raw materials relative to the compressive fluid. Note that, in the present embodiment, the raw materials, such as the ring-opening polymerizable monomer, can be brought into continuous contact with the compressive fluid at constant concentration rate in the blending device 9 by continuously supplying the raw materials and the compressive fluid, and as a result of this, the raw materials can be efficiently dissolved or melted.

A shape of the container of the blending device 9 may be a tank shape or a tubular shape, but it is preferably a tubular shape from one end of which the mixture is taken out. A container of the blending device 9 is provided with an inlet 9a for introducing a compressive fluid supplied from the tank 7 by the metering pump 8, an inlet 9b for introducing the ring-opening polymerizable monomer supplied from the tank 1 by the metering feeder 2, an inlet 9c for introducing the powder supplied from the tank 3 by the metering feeder 4, and an inlet 9d for introducing the liquid supplied from the tank 5 by the metering pump 6. In the present embodiment, each inlet (9a, 9b, 9c, 9d) is constituted of a connector for connecting the container of the blending device 9 with each pipe for transporting each of the raw materials or compressive fluid. The connector is not particularly limited, and is selected from conventional reducers, couplings, Y, T, and outlets. The blending device 9, moreover, contains a heater 9e for heating each of the supplied raw materials and compressive fluid. Further, the blending device 9 may contain a stirring device for stirring the raw materials, and compressive fluid. In the case where the blending device 9 contains a stirring device, the stirring device is preferably a single screw stirring device, a twin-screw stirring device where screws are engaged with each other, a biaxial mixer containing a plurality of stirring elements which are engaged or overlapped with each other, a kneader containing spiral stirring elements which are engaged with each other, or a stick mixer. Among them, the two-axial or multi-axial stirrer stirring elements of which are engaged with each other is more preferable because there is generated a less amount of the depositions of the reaction product onto the stirrer or container, and it has self-cleaning properties.

In the case where the blending device 9 is not equipped with a stirring device, a pressure resistant pipe is suitably used as the blending device 9. In this case, an installation space of the polymerization reaction device 100 can be reduced, or the degree of freedom of the layout can be improved by providing the pressure resistant pipe in the spiral or bent manner. Note that, in the case where the blending device 9 does not have a stirring device, the ring-opening polymerizable monomer to be supplied to the blending device 9 is preferably liquidized in advance to surely mix all the materials in the melt blending device 9.

The liquid transfer pump 10 sends each raw material dissolved or melted in the blending device 9 to the reaction vessel 13. The tank 11 stores the organic catalyst. The metering pump 12 measures the organic catalyst stored in the tank 11, and supplies the measured organic catalyst to the reaction vessel 13.

The reaction vessel 13 is a pressure resistant vessel for mixing each of the dissolved or melted raw materials sent by the liquid transfer pump 10 with the organic catalyst supplied by the metering pump 12 to continuously carrying out ring-opening polymerization of the ring-opening polymerizable monomer. A shape of the reaction vessel 13 may be a tank or a tube, but it is preferably a tube as it gives a less dead space. The reaction vessel 13 is provided with an inlet 13a for introducing the materials mixed by the blending device 9 into the vessel, and an inlet 13b for introducing the organic catalyst supplied from the tank 11 by the metering pump 12 into the vessel. In the present embodiment, each inlet (13a, 13b) is constituted of a connector for connecting the reaction vessel 13 with each pipe for transporting each of the raw materials. The connector is selected from conventional reducers, couplings, Y, T, and outlets. Note that, the reaction vessel 13 may be provided with a gas outlet for releasing evaporated materials. Moreover, the reaction vessel 13 contains a heater 13c for heating the transported raw materials. Further, the reaction vessel 13 may contain a stirring device for stirring the raw materials, and compressive fluid. A use of the reaction vessel 13 containing a stirring device can realize a uniform and quantitative polymerization reaction as it can prevent sedimentation of polymer particles caused by a concentration difference between the raw materials and the polymer product. The stirrer of the reaction vessel 13 is preferably a dual- or multi-axial stirrer having screws engaging with each other, stirring elements of 2-flights (rectangle), stirring elements of 3-flights (triangle), or circular or multi-leaf shape (clover shape) stirring wings, in view of self-cleaning. In the case where raw materials including the catalyst are sufficiently mixed in advance, a motionless mixer, which divides the flow and compounds (recombines the flows in multiple stages, can also be used as the stirring device. Examples of the motionless mixer include: multiflux batch mixers disclosed in Japanese examined patent application publication (JP-B) Nos. 47-15526, 47-15527, 47-15528, and 47-15533; a Kenics-type (static) mixer disclosed in JP-A No. 47-33166; and motionless mixers similar to those listed.

In the case where the reaction vessel 13 is not equipped with a stirrer, a pressure resistant pipe is suitably used as the reaction vessel 13. In this case, an installation space of the polymerization reaction device 100 can be reduced, or the degree of freedom of the layout can be improved by providing the pressure resistant pipe in the spiral or bent manner.

FIG. 3 illustrates an embodiment where one reaction vessel 13 is used, but a device with two or more reaction vessels 13 can be also used. In the case where a plurality of reaction vessels 13 are used, the reaction (polymerization) conditions per reaction vessel 13, i.e., conditions, such as the temperature, concentration of the catalyst, the pressure, the average retention time, and stirring speed, can be the same as in the case only one reaction vessel 13 is used, but they are preferably optimized per reaction vessel 13 corresponding to the progress of the polymerization (the stage of the polymerization). Note that, it is not very good idea that excessively large number of containers is connected to give many stages, as it may extend a reaction time, or a device may become complicated. The number of stages is preferably 1 to 4, more preferably 1 to 3.

In the case where polymerization is performed with only one reaction vessel, a polymerization degree of an obtained polymer or an amount of monomer residues in the polymer are generally unstable, and tend to be varied, and therefore it is not suitable in industrial productions. It is considered that the instability thereof is caused because raw materials having the melt viscosity of a few poises to several tends poises and the polymerized polymer having the melt viscosity of approximately 1,000 poises are present together in the same container. In the present embodiment, compared to the above, the viscosity difference within the system can be reduced by dissolving or melting the raw materials and polymers in the compressive fluid, so that the number of the stages can be reduced compared to that in the conventional polymerization reaction device.

The metering pump 14 discharges the polymer product P polymerized in the reaction vessel 13 from a discharge nozzle 15, which is one example of a polymer outlet to outside the reaction vessel 13. Alternatively, the polymer product P may be discharged from the reaction vessel 13 by utilizing a pressure difference between the inside and outside the reaction vessel 13, without using the metering pump 14. In this case, instead of the metering pump 14, a pressure adjustment valve may be used, so as to adjust an internal pressure of the reaction vessel 13 or a discharging amount of the polymer product P.

Subsequently, a batch-system polymerization step of a ring-opening polymerizable monomer using a polymerization reactor 200 will be explained. In the system diagram of FIG. 4, the polymerization reaction device 200 contains a tank 21, a metering pump 22, an addition pot 25, a reaction vessel 27, and valves (23, 24, 26, 28, 29). Each of the devices above is connected with a pressure resistant pipe 30 as illustrated in FIG. 4. Moreover, couplings (30a, 30b) are provided to the pipe 30.

The tank 21 stores the compressive fluid. Note that, the tank 21 may contain gas or solid that is transformed into a compressive fluid upon application of heat or pressure in a supplying in a supply path through which it is supplied to the reaction vessel 27, or in the reaction vessel 27. In this case, the gas or solid stored in the tank 21 is transformed into the state of (1), (2), or (3) in the phase diagram of FIG. 2 in the reaction vessel 27 by applying heat or pressure.

The metering pump 22 supplies the compressive fluid stored in the tank 21 to the reaction vessel 27 at constant pressure and flow rate. The addition pot 25 stores the organic catalyst to be added to the raw materials in the reaction vessel 27. By opening and closing each of the valves (23, 24, 26, 29), the path is switched between a path for supplying the compressive fluid stored in the tank 21 to the reaction vessel 27 via the addition pot 25, and a path for supplying the compressive fluid to the reaction vessel 27 without passing through the addition pot 25.

The reaction vessel 27 is charged with the ring-opening polymerizable monomer and the initiator in advance to starting polymerization. The reaction vessel 27 is a pressure resistant vessel configured to bring the previously loaded ring-opening polymerizable monomer and initiator into contact with the compressive fluid supplied from the tank 21 and the organic catalyst supplied from the addition pot 25, to thereby carry out ring-opening polymerization of the ring-opening polymerizable monomer. The reaction vessel 27 may be provided with a gas outlet for releasing evaporated materials. Moreover, the reaction vessel 27 contains a heater for heating the transported raw materials. Further, the reaction vessel 27 may contain a stirring device for stirring the raw materials, and compressive fluid. A use of the reaction vessel 27 containing a stirring device can realize a uniform and quantitative polymerization reaction as it can prevent sedimentation of polymer particles caused by a concentration difference between the raw materials and the polymer product with stirring by the stirring device. The valve 28 discharges the polymer product P in the reaction vessel 27 by opening after the completion of the polymerization reaction.

### <<Polymerization Method>>

Next, a polymerization method of a ring-opening polymerizable monomer using the polymerization reaction device 100 as one example of the polymerization reaction device. First, each of the metering feeders (2, 4), the metering pump 6, and the metering pump 8 is operated to continuously introduce a ring-opening polymerizable monomer, initiator, additives, and compressive fluid in the tanks (1, 3, 5, 7) into the blending device 9 through respective inlets (9a, 9b, 9c, 9d). Note that, the weight accuracy of solid (powder or granular) raw materials of polymerization may be low compared to that of the liquid raw materials. In this case, the solid raw materials may be formed into a liquid to be stored in the tank 5, and then introduced into a container of the blending device 9 by the metering pump 6. The order for operating the metering feeders (2, 4) and the metering pump 6 and metering pump 8 are not particularly limited, but it is preferred that the metering pump 8 be operated first because there is a possibility that raw materials are solidified if the initial raw materials are sent to the reaction vessel 13 without being in contact with the compressive fluid.

Since the raw materials and the compressive fluid are each continuously introduced into a container of the blending device 9, they are continuously brought into contact with each other. As a result, each of the raw materials, such as the ring-opening polymerizable monomer, the initiator, and the additives, are dissolved or melted in the blending device 9. In the case where the blending device 9 contains a stirring device, the raw materials and compressive fluid may be stirred. In order to prevent the introduced compressive fluid from turning into gas, the internal temperature and pressure of the container of the reaction vessel 13 are controlled to the temperature and pressure both equal to or higher than at least a triple point of the compressive fluid. The control of the temperature and pressure here is performed by adjusting the output of the heater of the blending device 9, or adjusting the feeding speed of the compressive fluid. In the present embodiment, the temperature for dissolving or melting the ring-opening polymerizable monomer may be the temperature equal to or lower than the melting point of the ring-opening polymerizable monomer under atmospheric pressure. It is assumed that the internal pressure of the blending device 9 becomes high under the influence of the compressive fluid so that the melting point of the ring-opening polymerizable monomer reduces the melting point thereof under the atmospheric pressure. Accordingly, the ring-opening polymerizable monomer is dissolved or melted in the blending device 9, even when an amount of the compressive fluid is small with respect to the ring-opening polymerizable monomer.

In order to dissolve or melt each of the raw materials efficiently, the timing for applying heat to or stirring the raw materials and compressive fluid in the blending device 9 may be adjusted. In this case, heating or stirring may be performed after bringing the raw materials and compressive fluid into contact with each other, or heating or stirring may be performed while bringing the raw materials and compressive fluid into contact with each other. To make dissolving or melting of the materials even more certain, for example, the ring-opening polymerizable monomer and the compressive fluid may be brought into contact with each other after heating the ring-opening polymerizable monomer at the temperature equal to or higher than the melting point thereof. In the case where the blending device 9 is a biaxial mixing device, for example, each of the aforementioned aspects may be realized by appropriately setting an alignment of screws, arrangement of inlets (9a, 9b, 9c, 9d), and temperature of the heater 9e of the blending device 9.

In the present embodiment, the additives are supplied to the blending device 9 separately from the ring-opening polymerizable monomer, but the additives may be supplied together with ring-opening polymerizable monomer. Alternatively, the additives may be supplied after completion of a polymerization reaction. In this case, after taking the obtained polymer product out from the reaction vessel 13, the additive may be added to the polymer product while kneading the mixture of the additives and polymer product.

Each of the raw materials dissolved or melted in blending device 9 is sent by the liquid transfer pump 10, and supplied to the reaction vessel 13 through the inlet 13a. Meanwhile, the organic catalyst in the tank 11 is measured by the metering pump 12, and a predetermined amount of the organic catalyst is supplied to the reaction vessel 13 through the inlet 13b. The organic catalyst can function even at room temperature, and therefore, in the present embodiment, addition of the organic catalyst directly to the blending device 9 is avoided, and the organic catalyst is added after dissolving or melting the raw materials in the compressive fluid. In the conventional art, the timing for adding the catalyst has not been discussed in the ring-opening polymerization of the ring-opening polymerizable monomer in the compressive fluid. In the present embodiment, in the course of the ring-opening polymerization, the organic catalyst is added to the polymerization system in the reaction vessel 13 because of the high activity of the organic catalyst, where the polymerization system contains a mixture of raw materials such as the ring-opening polymerizable monomer and the initiator sufficiently dissolved or plasticized in the compressive fluid. When the organic catalyst is added in the state where the mixture is not sufficiently dissolved or melted, the reaction progresses unevenly to cause variations in viscosity, and therefore it may be difficult to produce as a generated product, a polymer having a high molecular weight.

Each of the raw materials sent by the liquid transfer pump 10 and the organic catalyst supplied by the metering pump 12 are optionally sufficiently stirred by the stirring device of the reaction vessel 13, and heated to the predetermined temperature by the heater 13c. As a result, ring-opening polymerization reaction of the ring-opening polymerizable monomer is carried out in the reaction vessel 13 in the presence of the organic catalyst (polymerization step).

The lower limit of the temperature of ring-opening polymerization (polymerization reaction temperature) of the ring-opening polymerizable monomer is not particularly limited, but it is 40° C., preferably 50° C., and more preferably 60° C. When the reaction temperature is lower than 40° C., it may take a long time to dissolve or melt the ring-opening polymerizable monomer in the compressive fluid, depending on a type of the ring-opening polymerizable monomer, dissolution or melting thereof in the compressive fluid may be insufficient, or the organic catalyst may exhibit low activity. As a result, reaction speed may be low during the polymerization, by which the polymerization reaction may not be able to progress quantitatively.

The upper limit of the polymerization reaction temperature is not particularly limited, but it is 100° C., or the temperature higher than the melting point of the ring-opening polymerizable monomer by 30° C., whichever higher. The upper limit of the polymerization reaction temperature is preferably 90° C., or the melting point of the ring-opening polymerizable monomer, whichever higher. More preferably, the upper limit of the polymerization reaction temperature is 80° C., or the temperature lower than the melting point of the ring-opening polymerizable monomer by 20° C., whichever higher. When the polymerization reaction temperature is higher than the temperature that is higher than the ring-opening polymerizable monomer by 30° C., a depolymerization reaction, which is a reverse reaction of ring-opening polymerization, tends to occur equibliumly, by which the polymerization reaction may not be progressed quantitatively. In the case where a ring-opening monomer having a low melting point, such as a ring-opening polymerizable monomer in the state of a liquid at room temperature, the polymerization reaction temperature may be set to the temperature higher than the melting point by 30° C. to activate the organic catalyst. Even in this case, the polymerization reaction temperature is preferably 100° C. or lower. Note that, the polymerization reaction temperature is controlled by heating by means of the heater 13c equipped with the reaction vessel 13, or externally heating the reaction vessel 13.

In the present embodiment, the polymerization reaction time (the average retention time in the reaction vessel 13) is set depending on a target molecular weight. When the target number average molecular weight is 15,000 or greater, the polymerization reaction time is generally 10 minutes to 6 hours, though it depends on other conditions.

The pressure during the polymerization, that is, the pressure of the compressive fluid may be pressure at which the compressive fluid supplied from the tank 7 is liquid gas ((2) in the phase diagram of FIG. 2), or high pressure gas ((3) in the phase diagram of FIG. 2), but it is preferably pressure at which the compressive fluid is supercritical fluid ((1) in the phase diagram of FIG. 2). By making the compressive fluid into the state of a supercritical fluid, dissolution or melting of the ring-opening polymerizable monomer is accelerated to uniformly and quantitatively progress a polymerization reaction. In the case where carbon dioxide is used as the compressive fluid, the pressure thereof is 3.7 MPa or higher, preferably 5 MPa or higher, more preferably 7.4 MPa or higher, which is the critical pressure or higher, in view of efficiency of a reaction and polymerization rate. In the case where carbon dioxide is used as the compressive fluid, moreover, the temperature thereof is preferably 25° C. or higher from the same reasons to the above. In the present embodiment, the concentration of the compressive fluid is not particularly limited as long as it is a concentration at which the ring-opening polymerizable monomer and a polymer generated from the ring-opening polymerizable monomer can be dissolved or melted in the compressive fluid.

An amount of moisture in the reaction vessel 13 is preferably 4 mol % or smaller, more preferably 1 mol % or smaller, and even more preferably 0.5 mol % or smaller, relative to 100 mol % of the ring-opening polymerizable monomer. When the amount of the moisture is greater than 4 mol %, the moisture itself contributes as an initiator, and therefore it may be difficult to control a molecular weight of a polymer product. In order to control an amount of moisture in the polymerization reaction system, a process for removing moisture contained in the ring-opening polymerizable monomer or other raw materials may be performed as a pre-treatment.

The polymer product P completed with the ring-opening polymerization reaction in the reaction vessel 13 is discharged outside the reaction vessel 13 by means of the metering pump 14. The speed for discharging the polymer product P by the metering pump 14 is preferably constant so as to keep the internal pressure of the polymerization system filled with the compressive fluid constant, and to yield a uniform polymer product. To this end, the liquid sending system inside the reaction vessel 13 and the amount for sending the liquid by the liquid transfer pump 10 are controlled to maintain the back pressure of the metering pump 14 constant. Similarly, the liquid sending system inside the blending device 9, and the feeding speeds of the metering feeders (2, 4) and metering pumps (6, 8) are controlled to maintain the back pressure of the liquid transfer pump 10 constant. The control system may be an ON-OFF control system, i.e., an intermittent feeding system, but it is in most cases preferably a continuous or stepwise control system where the rational speed of the pump or the like is gradually increased or decreased. Any of these controls realizes to stably provide a uniform polymer product.

The organic catalyst remained in the polymer product obtained in the present embodiment is removed, if necessary. As a result of this removal, the amount of the organic catalyst residues in the polymer product can be reduced to 2% by mass. A method for removing the organic catalyst is not particularly limited, and examples thereof include: vacuum distillation in case of a compound having a boiling point; a method for extracting and removing the organic catalyst using a compound dissolving the organic catalyst as an entrainer; and a method for absorbing the organic catalyst with a column to remove the organic catalyst. In method for removing the organic catalyst, a system thereof may a batch system where the polymer product is taken out from the reaction vessel and then the organic catalyst is removed therefrom, or a continuous processing system where the organic catalyst is removed in the reaction vessel without taking the polymer product out of the reaction vessel. In the case of vacuum distillation, the vacuum condition is set based on a boiling point of the organic catalyst. For example, the temperature in the vacuum is 100° C. to 120° C., and the organic catalyst can be removed at the temperature lower than the temperature at which the polymer product is depolymerized. If an organic solvent is used in the process of extraction, it may be necessary to provide a step for removing the organic solvent after extracting the organic catalyst. Therefore, it is preferred that a compressive fluid be used as a solvent for the extraction. As for the process of such extraction, conventional techniques used for extracting perfumes may be diverted.

### Applied Example

In accordance with the production method of the present embodiment, a reaction progresses quantitatively without hardly giving monomer residues. Therefore, it is possible to synthesize a copolymer containing two or more polymer segments, or to produce a mixture of polymers, by appropriately adjusting the timing for adding a plurality of ring-opening polymerizable monomers. Two production methods of a stereo complex, which is one example of the aforementioned copolymer or mixture, will be presented below.

A first method includes polymerizing a ring-opening polymerizable monomer (e.g., L-lactide) in the reaction vessel 13, and after completing the reaction quantitatively, adding another optical isomeric ring-opening polymerizable monomer (e.g., D-lactide) to the reaction vessel 13, to thereby carry out a polymerization reaction. As a result, a stereo complex (stereo block copolymer) is obtained. This method is very effective because recemization hardly occurs, because the reaction is carried out at the temperature equal to or lower than the melting point of the ring-opening polymerizable monomer with the state where there are fewer monomer residues, and because a complex is produced by a reaction of one stage.

In the second method, polymers (e.g., polylactic acid) of L-form and D-form are each separately formed by polymerization in a compressive fluid in the polymerization reaction device 100. Then, these obtained polymers are mixed in the compressive fluid to obtain a stereo complex. Generally, a polymer such as polylactic acid tends to be decomposed as it is re-heated and re-dissolved, even when the polymer has fewer monomer residues. The second method is effective because, similarly to the first method, racemization or thermal deterioration can be inhibited by blending low viscous polylactic acids dissolved or melted in the compressive fluid.

### <<Polymer Product>>

In accordance with the production method of the present embodiment, a polymerization reaction can be performed at low temperature by using a compressive fluid, as described above, and therefore a depolymerization reaction is significantly inhibited compared to a conventional melt polymerization method. Accordingly, an amount of the ring-opening polymerizable monomer residues contained in the polymer product can be reduced, specifically, to 2% by mass or smaller, preferably 0.5% by mass or smaller, and more preferably 0.1% by mass (1,000 ppm) or smaller. Further, in the present embodiment, the amount of the ring-opening polymerizable monomer residues can also be reduced to 300 ppm or smaller, preferably 100 ppm or smaller. Notably, in the present embodiment, the amount of the ring-opening polymerizable monomer residues can be expressed as a mass ratio; i.e., [the mass of the ring-opening polymerizable monomer residues/the total mass of the ring-opening polymerizable monomers (=the mass of the polymer product containing the ring-opening polymerizable monomer residues)]. The amount of the ring-opening polymerizable monomer residues can be measured based on “Voluntary Standard for Food Containers and Wrappings Formed of Synthetic Resin such as Polyolefin, the third revised edition, added in June, 2004, Part 3, Standard Methods of Analysis for Hygienic Chemists.” When the amount of the ring-opening polymerizable monomer residues is greater than 2 mol %, heat resistant stability reduces as thermal properties thereof decrease, and moreover the decomposition of the polymer tends to progress as carboxylic acid generated by ring-opening of the monomer residue functions as a catalyst for accelerating hydrolysis decomposition. In the case where the monomer is volatile, a nozzle or mold may be smeared when the polymer product is processed depending on its use, such as fibers, a film, or a molded article, which may lower production efficiency, or impair quality of a product itself. Accordingly, the polymer product obtained in the present embodiment significantly increases its stability with respect to the aforementioned properties. Note that, in accordance with the present embodiment, the polymer product containing the ring-opening polymerizable monomer residues in an amount of 2% by mass or smaller, preferably 1,000 ppm or smaller, can be obtained by appropriately selecting each of the aforementioned polymerization conditions, without a removal treatment that is separately performed. The amount of the ring-opening polymerizable monomer residues may be greater than 2 mol % if physical properties of a polymer product suitable for an intended use can be attained.

The number average molecular weight of the polymer product of the present embodiment can be appropriately adjusted depending on the intended use without any limitation, but it is 12,000 or greater, preferably 15,000 or greater. Note that, in the present embodiment, the number average molecular weight is calculated based on a measurement of gel permeation chromatography (GPC). When the number average molecular weight is smaller than 12,000, a resulting polymer is frail, which may limit a use thereof in the application. A value obtained by dividing the weight average molecular weight Mw of the polymer obtained in the present embodiment with the number average molecular weight Mn thereof is preferably 1.2 to 2.5, more preferably 1.2 to 2.0, and even more preferably 1.2 to 1.5. When this value is greater than 2.5, an amount of the low molecular weight component increases, which may increase degradability.

The polymer product obtained in the present embodiment is excellent in safety and stability, because the polymer product is substantially free from a metal atom and an organic solvent, and has an extremely small amount of the ring-opening polymerizable monomer residues, which is 2% by mass or smaller, preferably 0.1% by mass (1,000 ppm) or smaller, as the polymer product is produced by the production method that does not use a metal catalyst and an organic solvent. Accordingly, the particles of the present embodiment are widely applied in various uses, such as daily use product, pharmaceutical products, cosmetic products, and electrophotographic toners. Note that, in the present embodiment, the term “metal catalyst” refers to a catalyst, which is used for ring-opening polymerization, and contains a metal atom. The phrase “substantially free from a metal atom” refers to not containing a metal atom derived from the metal catalyst. Specifically, a polymer product can be said it is substantially free from a metal atom, when the metal atom derived from the metal catalyst in the polymer product is detected by conventional analysis methods, such as ICP-atomic emission spectrometry, atomic absorption spectrophotometry, and colorimetry, and the result is equal to or lower than the detection limit. The metal catalyst is not particularly limited, but examples thereof include conventional metal catalyst, such as a tin compound (e.g., tin octylate, tin dibutylate, and tin bis(2-ethylhexanoate)), an aluminum compound (e.g., aluminum acetylacetonate, and aluminum acetate), a titanium compound (e.g., tetraisopropyl titanate, and tetrabutyl titanate), a zirconium compound (e.g., zirconium isopropoxide), and an antimony compound (e.g., antimony trioxide). Examples of the metal atom derived from the metal catalyst include tin, aluminum, titanium, zirconium, and antimony. In the present embodiment, moreover, the term “organic solvent” is an organic solvent used for ring-opening polymerization, and selected from those that can dissolve a polymer obtained through a ring-opening polymerization reaction. In the case where a polymer obtained through a ring-opening polymerization reaction is polylactic acid (L-form 100%), examples of the organic solvent include: a halogen solvent, such as chloroform, and methylene chloride; and tetrahydrofuran. The fact “substantially free from an organic solvent” means that the amount of the organic solvent in the polymer product is the detection limit or smaller as measured by the following method.

### <Measurement Method of Organic Solvent Residues>

To 1 part by mass of the polymer product, which is a subject of the measurement, 2 parts by mass of 2-propanol was added, and the resultant was dispersed for 30 minutes by ultrasonic waves. Then, the resultant is stored in a refrigerator (5° C.) for 1 day or longer, to thereby extract an organic solvent in the polymer product. The supernatant fluid thus obtained was analyzed by gas chromatography (GC-14A, SHIMADZU), to determine the organic solvent and the monomer residues in the polymer product, and to thereby measure a concentration of the organic solvent. The measuring conditions of this analysis are as follows.

### Device: GC-14A Shimadzu

### Column: CBP20-M 50-0.25

### Detector: FID

Injection amount: 1 μL to 5 μL
Carrier gas: He, 2.5 kg/cm²
Flow rate of hydrogen: 0.6 kg/cm²
Flow rate of air: 0.5 kg/cm²
Chart speed: 5 mm/min

### Sensitivity: Range 101×Atten 20

Column temperature: 40° C.
Injection temperature: 150° C.

The polymer product produced by the aforementioned production method has a less amount of the monomer residues, and extremely low reaction temperature, because of which discoloration, mainly yellowing, can be inhibited, and hence the polymer product is white in color. Note that, the degree of yellowing can be evaluated with the value of YI, which is determined by preparing a 2 mm-thick resin pellet, and measuring the pellet by means of a SM color computer (manufactured by Suga Test Instruments Co., Ltd.) in accordance with JIS-K7103.

### (Polymer Compact)

A polymer compact, such as particles, a film, a sheet, a molded article, fibers, and foam, which can be obtained by shaping the polymer product produced by the aforementioned production method, will be explained. Note that, in the present embodiment, the polymer compact is an article produced by shaping the polymer product.

### <Particles>

A method for forming the polymer product obtained by the aforementioned production method into particles includes a method for pulverizing the polymer product in accordance with a conventional method. Particle diameters of the particles are generally 1 μm to 50 μm. In the case where the formed particles out of the polymer compact are an electrophotographic toner, a mixture, in which a colorant and hydrophobic particles are mixed in the polymer product, is produced. The mixture may contain other additives than a binder resin, a colorant, and hydrophobic particles. Examples of the aforementioned other particles include a releasing agent, and a charge controlling agent. The additives may be mixed in during the polymerization reaction, or in a post process of the polymerization reaction. Alternatively, the additives may be added during melt-kneading, after taking the polymer product from the polymerization system.

### <Film>

In the present embodiment, the film is a polymer component formed into a thin film having a thickness of less than 250 μm. In the present embodiment, the film is produced by drawing the polymer product obtained by the aforementioned production method.

In this case, the drawing method is not particularly limited, but a uniaxial drawing method, and concurrent or simultaneous biaxial drawing method (e.g., a tubular method, and a tenter method) can be employed.

A film is generally formed in a temperature range of 150° C. to 280° C. The formed film is subjected to monoaxial or biaxial drawing by a roll method, a tenter method, or a tublar method. The drawing temperature is typically 30° C. to 110° C., preferably 50° C. to 100° C. A draw magnification is typically 0.6 times to 10 times each in a longitudinal direction and a transverse direction. Moreover, after drawing, a heat treatment may be performed, and examples of such heat treatment include a method for blowing hot air, a method for applying infrared rays, a method for applying microwaves, and a method for bringing into contact with a heat roller.

In accordance with the aforementioned drawing method, various stretched films, such as a stretched sheet, a flat yarn, a stretched tape or band, a tape with linear supports, and a split yarn can be obtained. A thickness of the stretched film is appropriately selected depending on use thereof, but it is typically 5 μm or greater, but less than 250 μm.

Note that, the formed stretched film may be subjected to various secondary treatments for various purposes in order to impart a chemical function, electrical function, magnetic function, mechanical function, frictional, abrasive or lubricant function, optical function, thermal function, or surface function such as biocompatibility. Examples of the secondary treatment include embossing, coating, bonding, printing, metalizing (plating etc.), machining, and surface treatments (e.g., an antistatic treatment, a corona discharge treatment, a plasma treatment, a photochromism treatment, physical vapor deposition, chemical vapor deposition, and coating).

The stretched film obtained in the present embodiment is excellent in safety and stability because the stretched film uses the polymer product produced by the production method that does not use a metal catalyst and an organic solvent, does not contain the metal catalyst and the organic solvent, and contains an extremely small amount of the monomer residues, that is 2 mol % or smaller, preferably 0.1% by mass (1,000 parts per million by mass) or smaller. Accordingly, the stretched film of the present embodiment can be widely applied in various uses, such as daily use products, wrapping materials, pharmaceutical products, materials for electrical machinery and apparatus, casings of household electric appliances, and automotive materials. In the case where the obtained polymer product is a polymer having biodegradability, such as polylactic acid, and polycaprolactone, the polymer product can be effective for uses by which the polymer product may be taken into human bodies, such as wrapping materials used for foods, cosmetic products, and medical materials for pharmaceutical products, by utilizing the property thereof that a solvent and metal are not contained therein.

### <Sheet and Molded Article>

In the present embodiment, a sheet is a polymer component formed into a thin film having a thickness of 250 or greater. In the present embodiment, a sheet is produced by applying a conventional sheet production method for a thermoplastic resin to the polymer product obtained in the aforementioned production method. Such a method is not particularly limited, and examples thereof include a T-die method, an inflation method, and a calendering method. The processing conditions when it is processed into a sheet are appropriately determined depending on a type of the polymer product, and a device for use. For example, in the case where polylactic acid is processed by a T-die method, sheet processing can be performed by extruding the polymer product heated, preferably to the range of 150° C. to 250° C., by means of an extrusion molding device disposed at an outlet of the T-die, thereby discharging the polymer product from the T-die as a sheet.

In the present embodiment, the molded article is an article processed with a mold. The definition of the molded article includes parts formed of a molded article, such as handles of a tray, and a product equipped with a molded article, such as a tray provided with handles, as well as a molded article itself.

The processing method is not particularly limited, and the processing can be performed in a conventional method for a thermoplastic resin. Examples thereof include injection molding, vacuum molding, compression molding, vacuum compression molding, and press molding. A molded article may be produced by melting the polymer product obtained in the aforementioned production method, followed by injection molding. Moreover, a molded article may be obtained by press molding the sheet obtained in the aforementioned production method using a mold to give a shape. The processing conditions for giving a shape are appropriately determined depending on a type of the polymer product, and a device for use. For example, in the case where a shape is given to the sheet of the polylactic acid of the present embodiment by press molding using a mold, the temperature of the mold can be set to the range of 100° C. to 150° C. In the case where a shape is given by injection molding, the polymer product heated to the range of 150° C. to 250° C. is injected into a mold, and the temperature of the mold is set to the approximate range of 20° C. to 80° C., to perform injection molding.

Conventionally, a generally used polylactic acid rein contain large residual rates of a metal catalyst, organic solvent, and monomer. When such polylactic acid is heated to form into a sheet, a resulting sheet has impaired appearance due to a fish-eye defect that is a residue, such as a metal catalyst, organic solvent, and monomer, appeared on the sheet, and strength of the sheet may decrease. When molding is performed with polylactic acid by molding, or injection molding, the appearance is impaired similarly to the above, and the strength may decrease.

Conversely, the sheet and molded articles of the present embodiment are produced by using the polymer product, which is produced in the production method that does not use a metal catalyst and an organic solvent, is free from a metal atom and an organic solvent, and has an extremely small amount of the monomer residues, that is 2% by mass or smaller, preferably 0.1% by mass (1,000 parts per million by mass) or smaller. Therefore, the sheet and molded article of the present embodiment are excellent in safety, stability, and appearance. Accordingly, the sheet and molded article of the present embodiment are widely applied, but not particularly limited, for various uses, such as industrial materials, daily use product, agricultural products, sheets for foods, pharmaceutical products, and cosmetic products, wrapping materials, and trays. In the case where the obtained polymer product is a polymer having biodegradability, such as polylactic acid, and polycaprolactone, the polymer product can be effective for uses by which the polymer product may be taken into human bodies, such as wrapping materials used for foods, cosmetic products, and medical sheets for pharmaceutical products, by utilizing the characteristic thereof that an organic solvent and metal atom are not contained therein.

### <Fibers>

The polymer product obtained in the aforementioned production method can be also applied for fibers, such as monofilaments, and multifilaments. Note that, in the present embodiment, the definition of the fibers include not only sole fibers, such as monofilaments, but also an intermediate product constituted of fibers such as a woven fabric, and nonwoven fabric, and a product containing a woven fabric or nonwoven fabric, such as a mask.

In the present embodiment, in the case of monofilaments of the fibers, the fibers are produced by melt spinning the polymer product obtained in the aforementioned production method, cooling, and drawing in accordance with a conventional method, to thereby form the polymer product into fibers. Depending on use, a coating layer may be formed on each monofilament in accordance with a conventional method, and the coating layer may contain an antifungal agent, and a colorant. In the case of a nonwoven fabric, moreover, the fibers are produced, for example, by melt spinning the polymer product, cooling, drawing, splitting, depositing, and performing a heat treatment, to thereby form the polymer product into a nonwoven fabric. The polymer product may contain additives such as an antioxidant, a flame retardant, an UV absorber, an antistatic agent, an antifungal agent, and a binder resin. The additives may be mixed during the polymerization reaction, or in a post step after the polymerization reaction. Alternatively, the additives may be added to and mixed with the polymer product taken out from the reaction vessel, during the melt-kneading.

The fibers obtained in the present embodiment are excellent in safety and stability because it is formed by using the polymer product produced by the production method without using a metal catalyst and an organic solvent, and therefore the fibers do not include a metal atom and an organic solvent, and has an extremely small amount of the monomer residues, that is 2% by mass or smaller, preferably 0.1% by mass (1,000 parts per million by mass) or smaller. Accordingly, the fibers of the present embodiment are widely applied in various uses of monofilaments, such as fishing lines, fishing nets, surgical sutures, medical materials, materials of electrical machinery and apparatus, automotive materials, and industrial materials. Further, the fibers of the present embodiment are widely applied in various uses of a nonwoven fabric, such as fishery or agricultural materials, construction materials, interior accessories, automotive members, wrapping materials, commodities, and sanitary materials.

### <Foam>

The foam in accordance with the present embodiment is formed by foaming the polymer product produced in the aforementioned production method. The definition of the foam includes parts having foam such as a heat insulating material and a sound insulating material, and product containing foam such as construction materials, as well as a foam itself, such as a foam resin.

As for an effective production method of foam, there are a method in which foam is obtained by utilizing vaporization of a compressive fluid in the polymer product during reducing temperature or pressure of the polymer product dissolved or melted by the compressive fluid. It is considered that the compressive fluid in the polymer product is diffused at the speed of 10⁻⁵/sec to 10⁻⁶/sec once it is exposed to the atmosphere. When the pressure is released, the temperature decreases as the enthalpy is constant, and therefore it may be difficult to control a cooling speed. Even in such a case, a foam is formed with maintaining air bubbles in the case where the elasticity of the polymer is large at the time of exposure to the atmosphere.

In the case where a foam molded article is formed, the predetermined amount of the polymer product dissolved or melted by the compressive fluid is directly injected to a mold, the pressure is reduced, and then thermoforming is performed to thereby form a foam molded article. Examples of the heating member include steam, conductive heat, radiant heat, and microwaves. In this case, it is preferred that the polymer product be heated by any of these heating members to the approximate range of 100° C. to 140° C., or more preferably be heated by steam to the range of 110° C. to 125° C., thereby performing foam molding.

Moreover, a foam may be produced by applying a conventional production method of a foam plastic to the polymer product produced by the aforementioned production method. In this case, a resin composition, in which appropriate additives, such as a modifying agent, and a nucleating additive, are formulated with the polymer product, is extruded by means of a common hot melt extruder, to thereby obtain strands. From the obtained strands, pellets or particles are obtained by a pelletizer (granulation step). These particles or pellets are loaded in an autoclave, and a gas phase, or a liquid phase such as water and pure water is added thereto, to thereby prepare a resin particle dispersion liquid optionally using commonly used additives. Further, the resin particle dispersion liquid is foamed by using a volatile foaming agent to thereby obtain foam particles (foaming step). These particles are exposed to the atmosphere to penetrate the air into bubble cells in each particle, and optionally the moisture deposited on the particles is removed, if necessary (maturing step). Subsequently, a sealed mold having a small pore or slit is filled with these foam particles, followed by heat forming, to thereby obtain a polymer compact in which particles are fused to and integrated with each other.

The foam obtained in the present embodiment is excellent in safety and stability because it is formed by using the polymer product produced by the production method without using a metal catalyst and an organic solvent, and therefore the foam is free from a metal atom and an organic solvent, and has an extremely small amount of the monomer residues, that is 2% by mass or smaller, preferably 0.1% by mass (1,000 parts per million by mass) or smaller. Accordingly, the foam of the present embodiment are widely applied in various uses, such as a cushioning material, a heat insulating material, a sound insulating material, and a damping material.

### <Polymer Composition>

The polymer composition containing the polymer product produced by the aforementioned production method will be explained next. In the present embodiment, the term “polymer composition” means a material containing the polymer product. A form of the polymer composition is not particularly limited, as long as it contains the polymer product. For example, the polymer composition may be a solid containing the polymer product and additives, or a liquid containing the polymer product dissolved in a solvent, or a dispersion liquid in which the polymer product is dispersed in a dispersion medium.

The polymer composition obtained in the present embodiment is excellent in safety and stability because it is formed by using the polymer product produced by the production method without using a metal catalyst and an organic solvent, and therefore the polymer composition is free from a metal atom and an organic solvent, and has an extremely small amount of the monomer residues, that is 2% by mass or smaller, preferably 0.1% by mass (1,000 parts per million by mass) or smaller. Accordingly, the polymer composition of the present embodiment can be widely applied in various uses, such as daily use products, wrapping materials, pharmaceutical products, materials for electrical machinery and apparatus, casings of household electric appliances, and automotive materials. When the polymer composition contains the polymer product having biodegradability, such as polylactic acid, and polycaprolactone, the polymer composition can be effective for uses by which the composition may be taken into human bodies, such as wrapping materials used for foods, cosmetic products, and medical materials for pharmaceutical products, by utilizing the property thereof that a solvent and metal are not contained therein.

### Effect of Embodiments

The polymer product of the present embodiment is obtained through ring-opening polymerization of a ring-opening polymerizable monomer with a compressive fluid, and a metal atom-free organic catalyst. Therefore, the polymer product is substantially free from an organic solvent and a metal atom, and contains ring-opening polymerizable monomer residues in an amount of 2% by mass or smaller, preferably 0.1% by mass (1,000 parts per million by mass) or smaller, and has a number average molecular weight of 12,000 or greater. This polymer product can be produced without using an organic solvent, and has small amounts of the ring-opening polymerizable monomer residues and low molecular weight component. Accordingly, the polymer product has an effect of preventing safety or stability of particles of the polymer product from decreasing influenced by the residues or small molecular weight component. Also, there is an effect of preventing durability or a softening point of the polymer compact due to the low molecular weight component contained in the polymer product from lowering.

### EXAMPLES

The present invention will be more specifically explained with reference to Examples and Comparative Examples, but Examples shall not be construed to as limit the scope of the present invention in any way.

Physical properties of polymer products obtained in Examples and Comparative Examples were measured in the following manners.

### <Molecular Weight of Polymer>

The molecular weight of the polymer product was measured by gel permeation chromatography (GPC) under the following conditions.

Apparatus: GPC-8020 (product of TOSOH CORPORATION)
Column: TSK G2000HXL and G4000HXL (product of TOSOH CORPORATION)

### Temperature: 40° C.

### Solvent: Tetrahydrofuran (THF)

Flow rate: 1.0 mL/min

First, a calibration curve of molecular weight was obtained using monodispersed polystyrene serving as a standard sample. A polymer sample (1 mL) having a polymer concentration of 0.5% by mass was applied and measured under the above conditions, to thereby obtain the molecular weight distribution of the polymer. The number average molecular weight Mn and the weight average molecular weight Mw of the polymer were calculated from the calibration curve. The molecular weight distribution is a value calculated by dividing Mw with Mn.

### <Glass Transition Temperature (Tg)>

Device: DSC (Q2000, manufactured by TA Instruments)

A simple sealed aluminum pan charged with 5 mg to 10 mg of a sample was provided to a flow of measurement processes below.

First heating: 30° C. to 220° C. at 5° C./min., retaining for 1 minute after reaching 220° C.

Cooling: quenching to −20° C. without temperature control, and retaining for 1 minute after reaching −20° C.

Second heating: −20° C. to 180° C. at 5° C./min.

The glass transition temperature was determined by reading the value in the thermogram of the second heating by a mid-point method, and taking the read value as a glass transition temperature.

### <Softening Point>

Device: Flow tester (CFT-500D, manufactured by Shimadzu Corporation)

### Sample: 1.5 g

Heating rate: 10° C./min

### Load: 10 kg

Nozzle: diameter of 0.5 mm, length of 1 mm
Heating onset temperature: 50° C.
Preheating time: 300 seconds
½ method: The temperature at which a half of the sample started to flow was determined as a softening point.

### <Amount of Ring-Opening Polymerizable Monomer Residues>

An amount of the ring-opening polymerizable monomer residues in the polymer product (polylactic acid) was determined in accordance with a method for measuring an amount of lactide described in Voluntary Standard for Food Containers and Wrappings Formed of Synthetic Resin such as Polyolefin, the third revised edition, added in June, 2004, Part 3, Standard Methods of Analysis for Hygienic Chemists, p. 13. Specifically, the polymer product, such as polylactic acid, was homogeneously dissolved in dichloromethane. To this solution, a mixed solution of acetone and cyclohexane was added, to thereby again precipitate a polymer product. The supernatant liquid thus obtained was provided to gas chromatograph (GC) equipped with a flame ionization detector (FID), to separate monomer residues (lactide). The separated monomer residues were determined by the internal reference method, to thereby measure an amount of the monomer residues (an amount of the ring-opening polymerizable monomer residues) in the polymer product. Note that, the measurement of GC can be performed under the following conditions. In each table, “ppm” means “ppm by mass.”

### (GC Measurement Conditions)

Column: capillary column (DB-17MS, manufactured by J&W Scientific, 30 m (length)×0.25 mm (internal diameter), film thickness: 0.25 μm)
Internal standard: 2,6-dimethyl-γ-pyrone
Flow rate of column: 1.8 mL/min
Temperature of column: Retained at 50° C. for 1 minute.
Heated at constant speed of 25° C./min, and retained at 320° C. for 5 minutes.
Detector: flame ionization detector (FID)

### <Yellowing Index (YI Value)>

A 2 mm-thick resin pellet was formed from the obtained resin sample, and the resulting pellet was measured by means of a SM color computer (manufactured by Suga Test Instruments Co., Ltd.) in accordance with JIS-K7103 to thereby determine a YI value.

### <Amount of Catalyst Residues>

An amount of catalyst residues was calculated using the following equation based on the results of GPC and results of GC above.

Amount of catalyst residues=(peak area(% by mass) of the molecular weight of 1,000 or smaller determined from the GPC measurement result)−(amount(% by mass) of ring-opening polymerizable monomer residues determined from the GC measurement result)

### <Monofilament Tensile Strength>

The monofilament tensile strength was measured under conditions of constant extension specified in JIS L1030 8.5.1 standard test.

Device: UCT-100 Tensilon unversal tensile testing machine (manufactured by Orientec Co., Ltd.)
Grip interval: 30 cm
Tensile speed: 30 cm/min
Number of test performed: 10 times

### <Polymerization Reaction Device>

The polymerization reaction device 200 of FIG. 4 was used in Examples 1-1 to 1-16, Examples 2-1 to 2-13, Examples 3-1 to 3-14, Examples 4-1 to 4-16, Comparative Example 1-4, Comparative Example 2-4, Comparative Example 3-4, Comparative Example 4-4, Examples 5-1 to 5-19, and Comparative Examples 5-1 to 5-3. As a gas cylinder 21 of the polymerization reaction device 200, a CO₂ gas cylinder was used. As a reaction vessel 27 of the polymerization reaction device 200, a 100 mL pressure vessel of batch type was used.

In Examples 1-17, 3-15, and 3-16, the continuous-type polymerization reaction device 100 of FIG. 3 was used. The blending device 9 was a device, which contained a cylinder having an internal diameter (d) of 30 mm, equipped with a biaxial stirrer to which screws that engaged each other were provided, where two rotational axes were in the same rotational direction, and the rotational speed was 30 rpm. The reaction vessel 13 was a biaxial kneader (TME-18, manufactured by Toshiba Corporation).

### Example 1-1

A 100 mL reaction vessel 27 was charged with 90 parts by mass of lactide of L-lactic acid, 10 parts by mass of lactide of D-lactic acid, and 1.00 mol % of lauryl alcohol serving as an initiator relative to 100 mol % of the monomers, where the materials had been weighted in advance so that the mass of the entire system was 50 g. The resulting mixture was heated to 110° C., followed by introducing supercritical carbon dioxide (60° C., 15 MPa) by a metering pump 22, and the raw materials were dissolved with stirring for 10 minutes. After adjusting the internal temperature of the system to 60° C., the path of the compressive fluid was switch to the path passing through an addition pot 25. As a result, an organic catalyst (1,8-diazabicyclo[5.4.0]undec-7-ene (DBU), 2.0 mol %), which had been stored in the addition pot 25, was pushed out from the addition port to the reaction vessel 27 at the set pressure higher, by 1 MPa, than the internal pressure of the reaction vessel 27, whereby adding the organic catalyst from the addition pot 25 to the reaction vessel 27. Thereafter, the resulting mixture was allowed to react for 2 hours. After the completion of the reaction, a polymer product was discharged from a valve 28 while reducing the pressure. As a result, carbon dioxide was vaporized, to thereby yield the polymer product (polylactic acid). The obtained polymer product was formed into a foam by vaporizing the carbon dioxide present inside. The obtained polymer product was pulverized by means of a counter jet mill (manufactured by Hosokawa Micron Corporation), to thereby obtain particles having the volume average particle diameter of 6 μm. The obtained particles were subjected to the measurements of the physical properties as the polymer product in the aforementioned manners. The results are presented in Table 1.

### Examples 1-2 to 1-4

Polymer products of Examples 1-2 to 1-4 were each obtained in the same manner as in Example 1-1, provided that the amount of the initiator was changed to an amount depicted in a respective column of Examples 1-2 to 1-4 in Table 1. The obtained polymer product were each a foam as a result of vaporization of carbon dioxide present inside. Moreover, particles were obtained from the polymer product in the same manner as in Example 1-1. The obtained particles were subjected to the measurements of the physical properties as the polymer product in the aforementioned manners. The results are presented in Table 1.

### Examples 1-5 to 1-7

Polymer products of Examples 1-5 to 1-7 were each obtained in the same manner as in Example 1-3, provided that the reaction temperature was changed to temperature depicted in a respective column of Examples 1-5 to 1-7 in Table 1. The obtained polymer product were each a foam as a result of vaporization of carbon dioxide present inside. Moreover, particles were obtained from the polymer product in the same manner as in Example 1-1. The obtained particles were subjected to the measurements of the physical properties as the polymer product in the aforementioned manners. The results are presented in Table 1.

### Examples 1-8 to 1-10

Polymer products of Examples 1-8 to 1-10 were each obtained in the same manner as in Example 1-3, provided that the reaction pressure was changed to pressure depicted in a respective column of Examples 1-8 to 1-10 in Table 2. The obtained polymer product were each a foam as a result of vaporization of carbon dioxide present inside. Moreover, particles were obtained from the polymer product in the same manner as in Example 1-1. The obtained particles were subjected to the measurements of the physical properties as the polymer product in the aforementioned manners. The results are presented in Table 2.

### Examples 1-11 to 1-13

Polymer products of Examples 1-11 to 1-13 were each obtained in the same manner as in Example 1-3, provided that the reaction temperature and the reaction pressure were respectively changed to temperature and pressure depicted in respective columns of Examples 1-11 to 1-13 in Table 2. The obtained polymer product were each a foam as a result of vaporization of carbon dioxide present inside. Moreover, particles were obtained from the polymer product in the same manner as in Example 1-1. The obtained particles were subjected to the measurements of the physical properties as the polymer product in the aforementioned manners. The results are presented in Table 2.

### Examples 1-14 to 1-16

Polymer products of Examples 1-14 to 1-16 were each obtained in the same manner as in Example 1-3, provided that the monomer, catalyst, reaction pressure, and reaction temperature were respectively changed those depicted in respective columns of Examples 1-14 to 1-16 in Table 3. The obtained polymer product were each a foam as a result of vaporization of carbon dioxide present inside. Moreover, particles were obtained from the polymer product in the same manner as in Example 1-1. The obtained particles were subjected to the measurements of the physical properties as the polymer product in the aforementioned manners. The results are presented in Table 3.

### Example 1-17

A mixture of L-lactide and D-lactide (90/10) was polymerized by means of a continuous polymerization device of FIG. 3. As additives, a pigment (C.I. Pigment Yellow 185), carnauba wax, and a charge controlling agent (E-84, manufactured by Orient Chemical Industries Co., Ltd.) were used at the following proportions.

L-lactide/D-lactide mixture: 93 parts by mass
Pigment: 2 parts by mass
Carnauba wax: 4 parts by mass
Charge controlling agent: 1 part by mass

A gear pump (metering feeder 2) was operated to feed the lactide of the liquid state in the tank 1 to the blending device 9 at a constant rate. A gear pump (metering feeder 4) was operated to feed lauryl alcohol serving as an initiator in the tank 3 to the blending device 9 at a constant rate so that the lauryl alcohol was in an amount of 0.5 mol % relative to the lactide. The temperature of the cylinder of the blending device 9 was 80° C. Carbonic acid gas was fed from a vent port (inlet 9a) to adjust the inner pressure of the system to 15 MPa. The metering pump 12 was operated to feed a polymerization catalyst, DBU, in the tank 11 to a raw material feed orifice (inlet 13b) so that the polymerization catalyst was in an amount of 0.1% by mass relative to the lactide. The temperature of the cylinder of the reaction vessel 13 was adjusted so that the temperature of the area adjacent to the raw material feeding section was 80° C., and the temperature at the edge section was 60° C. Moreover, the average retention time of the reaction product in this vessel was about 1,200 seconds. A discharge nozzle was provided at the edge of the metering pump, and the resultant was extruded from the discharge nozzle in a form of a strand, to thereby obtain chips. The feeding rate of the polymer product by the metering pump 14 was 200 g/min.

Further, the chips were pulverized by means of a counter jet mill (manufactured by Hosokawa Micron Corporation), to thereby obtain color particles (a toner) having the volume average particle diameter of 6 μm. The obtained color particles were subjected to the measurements of the physical properties as the polymer product in the aforementioned manners. The results are presented in Table 3.

### Example 1-181

A polymer product of Example 1-18 was obtained in the same manner as in Example 1-17, provided that the monomer was changed to L-lactide (100%), the amount of the initiator was changed to an amount depicted in Table 4, and carbonic acid gas was introduced from the vent port (inlet 9a) at the flow rate of 10 g/min. Note that, the flow rate of 10 g/min was equivalent to 5% by mass of the polymer product feeding rate of 200 g/min by the metering pump 14. The obtained polymer product (L-poly lactic acid) was a foam as a result of vaporization of carbon dioxide present inside. Moreover, particles were obtained from the polymer product in the same manner as in Example 1-1. The obtained particles were subjected to the measurements of the physical properties as the polymer product in the aforementioned manners. The results are presented in Table 4.

### Example 1-19

The same operations were performed to those of Example 1-18, provided that the amount of the initiator was changed to an amount depicted in Table 4. The polymer product extruded in the form of a strand from the discharge nozzle 15 was immersed in water of 10° C., followed by cutting the strand with a cutter. The resultant was dried to thereby obtain pellets.

### Example 1-20

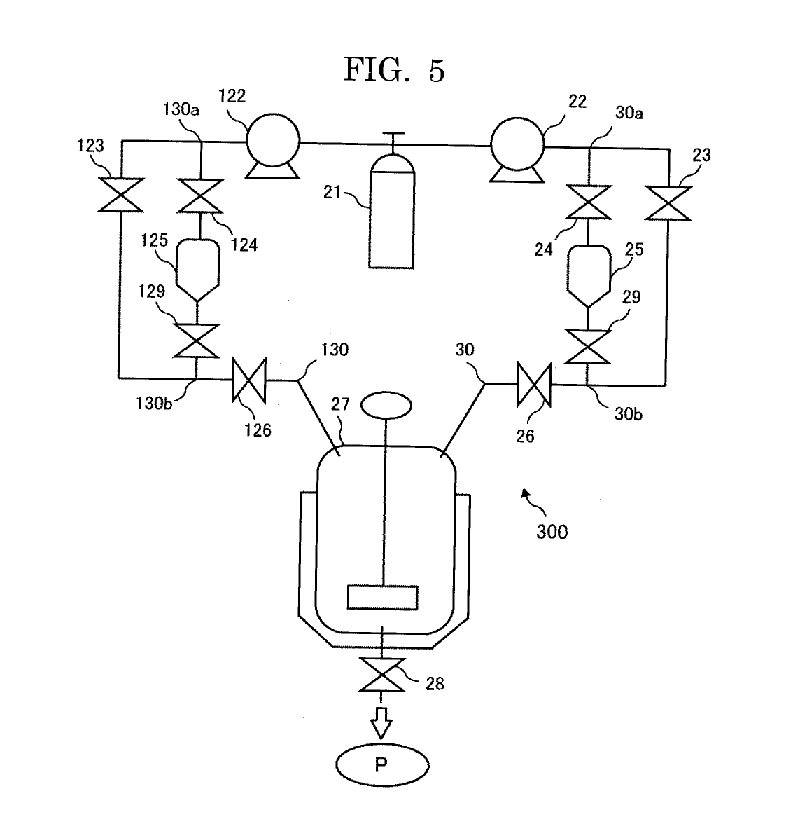

The L-polylactic acid obtained in Example 1-18 was used as an initiator, to which D-lactide (100%) was polymerized, to thereby form stereo complex. For the formation of the stereo complex, the polymerization reaction device 300 of FIG. 5 was used. FIG. 5 is a system diagram illustrating one example of a polymerization process of a batch system. The polymerization reaction device 300 had the same configuration to that of the polymerization reaction device 200 of FIG. 4, provided that the polymerization reaction device 300 had a pipe 130 provided with an addition pot 125, valves (123, 124, 126, 129), and couplings (130a, 130b). Note that, the addition pot 125, the valves (123, 124, 126, 129), and the pipe 130 were each respectively constituted of the same device, system, or means to those of the addition pot 25, the valves (23, 24, 26, 29), and the pipe 30. The operations performed in Example 1-20 were as follows.

A batch cell (reaction vessel 27) of FIG. 5 was charged with 25 g of the polymer product obtained in Example 1-18, followed by heating at 200° C. for 1 hour. Then, carbonic acid gas in the tank 21 was introduced to the batch sell so that the internal pressure thereof was to be 10 MPa, and it was cooled over the period of 1 hour until the temperature of the polymer product became 100° C. Thereafter, an organic catalyst (N,N-dimethyl-4-aminopyridine [DMAP]) loaded in the addition pot 25 in advance was pushed into the reaction vessel 27 at the pressure higher the internal pressure (10 MPa) of the reaction vessel 27, to thereby adjust the internal pressure of the reaction vessel 27 to 12 MPa. Then, the reaction vessel and its contents were left to stand for 2 hours.

Subsequently, the melted D-lactide (100%) (110° C.) loaded in the addition pot 125 was pushed into the reaction vessel 27, in the same manner with the aforementioned organic catalyst, at the pressure higher than the internal pressure of the reaction vessel 27 (12 MPa), to thereby adjust the internal pressure of the reaction vessel 27 to 15 MPa, followed by a reaction for 2 hours. After the completion of the reaction, the compressive fluid and the polymer product were discharged from the valve 28 while reducing the pressure, to thereby obtain a stereo complex copolymer of polylactic acid. Moreover, the obtained polymer product was subjected to the same operations as in Example 1-18, to thereby obtain pellets. The obtained pellets were subjected to the measurement of physical properties as the polymer product in the same manner as the above. The results are presented in Table 4.

### Comparative Example 1-1

In a flask, 90 parts by mass of lactide of L-lactic acid, 10 parts by mass of lactide of D-lactic acid, 0.5 mol % of lauryl alcohol serving as an initiator, relative to 100 mol % of monomers were measured under conditions of ambient pressure (0.1 MPa), so that the mass of the entire system became 50 g. Next, the contents in the flask was heated with purging the inner atmosphere with N₂. After visually confirming that the system was homogenized, tin bis(2-ethylhexanoate) was added as a catalyst in an amount of 2 mol % to thereby proceed to a polymerization reaction. During the polymerization reaction, the internal pressure of the system was controlled so as not to exceed 190° C. After 2 hours of the reaction, unreacted lactide was removed under conditions of reduced pressure, followed by taking out a polymer product (polylactic acid) in the flask. The obtained polymer product was pulverized by means of a counter jet mill (manufactured by Hosokawa Micron Corporation), to thereby obtain particles having the volume average particle diameter of 7 μm. The obtained particles were subjected to the measurement of physical properties as the polymer product in the same manner as the above. The results are presented in Table 3. Note that, “Sn” in Table 3 denotes tin bis(2-ethylhexanoate).

### Comparative Examples 1-2 and 1-3

Particles of Comparative Examples 1-2 and 1-3 were obtained in the same manner as in Comparative Example 1-1, provided that the monomer was changed to a respective column of Comparative Examples 1-2 and 1-3 in Table 3. The obtained particles were subjected to the measurement of physical properties as the polymer product in the same manner as the above. The results are presented in Table 3.

### Comparative Example 1-4

In a 100 mL-pressure resistant vessel, 90 parts by mass of lactide of L-lactic acid, 10 parts by mass of lactide of D-lactic acid, 1.00 mol % of lauryl alcohol serving as an initiator relative to 100 mol % of the monomers, and 2.0 mol % of 1,8-diazabicyclo[5.4.0]undec-7-ene (DBU) as an organic catalyst were measured and added so that the mass of the entire system became 50 g. A difference to Example 1-1 is the timing for adding the organic catalyst. Thereafter, the pressure resistant vessel was charged with supercritical carbon dioxide (60° C., 15 MPa). After the internal temperature of the system reached 60° C., the mixture in the pressure resistant vessel was allowed to react for 2 hours. After the completion of the reaction, the compressive fluid and a polymer product were discharged from the valve 28 while reducing the pressure. As a result, carbon dioxide was vaporized, to thereby obtain a polymer product (polylactic acid). The obtained polymer product was pulverized by means of a counter jet mill (manufactured by Hosokawa Micron Corporation), to thereby obtain particles having the volume average particle diameter of 6 μm. The obtained particles were subjected to the measurements of physical properties as the polymer product in the manners described above. The results are presented in Table 3. Note that, in Comparative Example 1-4, part of the polymer product was a foam, which was however unstable, and a polymer product in a state where the foam and bulk particles were mixed was obtained. A specific reason for this is not clear, but it is assumed that the number average molecular weight of the polymer product is small, which does not give sufficient elasticity of a polymer required for air holes when the compressive fluid is vaporized.

Moreover, the polymer products obtained in Example 1-1 and Comparative Example 1-4 were measured in the aforementioned manners. The data of glass transition temperatures and softening points thereof are presented in Table 5. The particles of Comparative Example 1-4 had low thermal properties represented by the glass transition temperature or softening point, as the molecular weight thereof was small. Therefore, the particles may be jointed to each other under high temperature conditions, which may restrict in applied use thereof.

### <Production Example of Toner>

A toner may be produced by adding a pigment, wax, a charge controlling agent, and the like to the polymer product obtained in each Example, such as Example 1-1, melt-kneading the mixture, pulverizing, and classifying the pulverized product. A production example of a toner is explained next.

The following raw materials of a master batch were mixed by means of HENSCHEL MIXER, to thereby obtain a mixture in which water was penetrated into the pigment aggregates.

### (Raw Materials of Master Batch)

Pigment (C.I. Pigment Yellow 185): 40 parts by mass
Polymer product (Example 1-1): 60 parts by mass
Water: 30 parts by mass

The resultant was kneaded by means of a two roll kneader, in which the rolls had the surface temperature set at 130° C., for 45 minutes, followed by pulverized into the size having a diameter of 1 mm by means of a pulverize, to thereby obtain a master batch.

In accordance with the following formulation of a toner, carnauba wax (molecular weight: 1,800, acid value: 2.7 mgKOH/g, penetration degree: 1.7 mm (40° C.)), the master batch, and a charge controlling agent (E-84, manufactured by Orient Chemical Industries Co., Ltd.) were mixed together and kneaded by means of a biaxial extruder at 100° C. The resultant was pulverized, and classified, to thereby obtain toner particles. To 100 parts by mass of the toner particles, 0.5 parts by mass of hydrophobic silica and 0.5 parts by mass of hydrophobic titanium oxide were added and mixed by means of HENSCHEL MIXER, to thereby obtain a toner.

### (Formulation of Toner)

Polymer product (Example 1-1): 90 parts by mass
Carnauba wax: 4 parts by mass
Master batch (prepared above): 5 parts by mass
Charge controlling agent: 1 part by mass

### [Production of Foam]

The polymer products (100 parts each) obtained in Comparative Examples 1-1 to 1-4 were each kneaded with 0.2 parts by mass of talc (Highfiller #12 of Matsumurasangyo, average particle diameter: 3 μm to 4 μm) serving as a nucleating additive (foam adjusting agent) by passing once through a open roll kneader (Kneadex, manufactured by Nippon Cole & Engineering Co., Ltd.) under the conditions that the temperature at the supplying side of the front roll was 120° C., the temperature at the discharging side thereof was 80° C., the temperature at the supplying side of the back roll was 30° C., the temperature at the discharging side thereof was 20° C., the rotation number of the front roll was 35 rpm, the rotation number of the back roll was 31 rpm, and the gap between the rolls was 0.25 mm. The resulting kneaded product was pulverized by a pulverizer (manufactured by Hosokawa Micron Corporation), to thereby obtain polymer particles.

The obtained polymer particles (100 parts by mass), 300 parts by mass of pure water, 0.02 parts by mass of tricalcium phosphate (average particle diameter: 0.5 μm) serving as a fusion inhibitor, and 0.0006 parts by mass of sodium dodecylbenzene sulfonate serving as a dispersant were placed in an autoclave having the internal volume of 500 mL. Then, nitrogen gas was introduced into the autoclave, to remove the oxygen inside the autoclave. The contents were heated to the foaming temperature (105° C.) while stirring, and carbon dioxide was injected into the autoclave until internal pressure of the autoclave became 45 kgf/cm² G (3.9 MPa), followed by retaining the temperature for 60 minutes. Thereafter, the contents were cooled to 95° C., and this temperature was retained for 5 minutes, followed by releasing one end of the autoclave to return the internal pressure to atmospheric pressure, to thereby obtain foam particles.

The foams of Examples and Comparative Examples each had the bulk density of 0.030 g/cm²±0.005 g/cm², and thermal conductivity of 0.035±0.005 (W/m·K). Each of the foams of Examples and Comparative Examples was a product that could be applied in use as a cushioning material, a heat insulating material, a sound insulating material, and a damping material. However, the compressive strength thereof is substantially correlated with a molecular weight of the polymer. When the number average molecular weight of the polymer is smaller than 15,000, the foam containing the polymer may have insufficient durability or heat resistance depending on use thereof. Moreover, it can be judged from the results presented in Tables 1 to 3 that the foams of Examples are superior to the foams of Comparative Examples in the stability of the foam itself, or safety concerned from catalyst residues. Further, the foams of Examples were produced at the same time as vaporization of carbon dioxide. Namely, the foams of Examples are efficiently produced compared to the foams of Comparative Examples.

TABLE 1

| | Ex. 1-1 | Ex. 1-2 | Ex. 1-3 | Ex. 1-4 | Ex. 1-5 | Ex. 1-6 | Ex. 1-7 |
|---|---|---|---|---|---|---|---|
| Catalyst | DBU | DBU | DBU | DBU | DBU | DBU | DBU |
| Monomer | Lactide | Lactide | Lactide | Lactide | Lactide | Lactide | Lactide |
| Initiator | Lauryl | Lauryl | Lauryl | Lauryl | Lauryl | Lauryl | Lauryl |
| | alcohol | alcohol | alcohol | alcohol | alcohol | alcohol | alcohol |
| Amount of | 1.00 | 0.75 | 0.50 | 0.25 | 0.50 | 0.50 | 0.50 |
| initiator | | | | | | | |
| (mol %) | | | | | | | |
| Pressure | 15 | 15 | 15 | 15 | 15 | 15 | 15 |
| (MPa) | | | | | | | |
| Temperature | 60 | 60 | 60 | 60 | 45 | 80 | 100 |
| (° C.) | | | | | | | |
| Reaction | 2 | 2 | 2 | 2 | 2 | 2 | 2 |
| time (hr) | | | | | | | |
| Number | 15,000 | 19,000 | 24,000 | 58,000 | 23,000 | 25,000 | 28,000 |
| average | | | | | | | |
| molecular | | | | | | | |
| weight (Mn) | | | | | | | |
| Molecular | 1.3 | 1.4 | 1.5 | 1.4 | 1.6 | 1.5 | 1.6 |
| weight | | | | | | | |
| distribution | | | | | | | |
| (Mw/Mn) | | | | | | | |
| Amount of | 200 | 100 | 500 | 700 | 600 | 500 | 300 |
| monomer | | | | | | | |
| residues | | | | | | | |
| (ppm) | | | | | | | |
| Amount of | 1.2 | 1.5 | 1.3 | 1.4 | 1.4 | 1.3 | 1.1 |
| catalyst | | | | | | | |
| residues | | | | | | | |
| (wt %) | | | | | | | |

TABLE 2

| | | | Ex. | Ex. | Ex. | Ex. |
|---|---|---|---|---|---|---|
| | Ex. 1-8 | Ex. 1-9 | 1-10 | 1-11 | 1-12 | 1-13 |
| Catalyst | DBU | DBU | DBU | DBU | DBU | DBU |
| Monomer | Lactide | Lactide | Lactide | Lactide | Lactide | Lactide |
| Initiator | Lauryl | Lauryl | Lauryl | Lauryl | Lauryl | Lauryl |
| | alcohol | alcohol | alcohol | alcohol | alcohol | alcohol |
| Amount of | 0.50 | 0.50 | 0.50 | 0.50 | 0.50 | 0.50 |
| initiator | | | | | | |
| (mol %) | | | | | | |
| Pressure | 5 | 10 | 30 | 5 | 10 | 30 |
| (MPa) | | | | | | |
| Temperature | 60 | 60 | 60 | 60 | 60 | 60 |
| (° C.) | | | | | | |
| Reaction | 2 | 2 | 2 | 0.1 | 0.5 | 1 |
| time (hr) | | | | | | |
| Number | 18,000 | 23,000 | 27,000 | 16,000 | 20,000 | 24,000 |
| average | | | | | | |
| molecular | | | | | | |
| weight (Mn) | | | | | | |
| Molecular | 1.5 | 1.6 | 1.4 | 1.5 | 1.6 | 1.4 |
| weight | | | | | | |
| distribution | | | | | | |
| (Mw/Mn) | | | | | | |
| Amount of | 700 | 700 | 800 | 800 | 800 | 900 |
| monomer | | | | | | |
| residues | | | | | | |
| (ppm) | | | | | | |
| Amount of | 1.3 | 1.4 | 1.5 | 1.4 | 1.2 | 1.3 |
| catalyst | | | | | | |
| residues | | | | | | |
| (wt %) | | | | | | |

TABLE 3

| | Ex. | Ex. | | Ex. | Comp. | Comp. | Comp. | Comp. |
|---|---|---|---|---|---|---|---|---|
| | 1-14 | 1-15 | Ex. 1-16 | 1-17 | Ex. 1-1 | Ex. 1-2 | Ex. 1-3 | Ex. 1-4 |
| Catalyst | DPG | TDB | DBU | DBU | Sn | Sn | Sn | DBU |
| Monomer | ε-capro | ε-capro | Ethylene | Lactide | Lactide | ε-capro | Ethylene | Lactide |
| | lactone | lactone | carbonate | | | lactone | carbonate | |
| Initiator | Lauryl | Lauryl | Lauryl | Lauryl | Lauryl | Lauryl | Lauryl | Lauryl |
| | alcohol | alcohol | alcohol | alcohol | alcohol | alcohol | alcohol | alcohol |
| Amount of | 0.50 | 0.50 | 0.50 | 0.50 | 0.50 | 0.50 | 0.50 | 1.00 |
| initiator | | | | | | | | |
| (mol %) | | | | | | | | |
| Pressure | 10 | 10 | 10 | 15 | 0.1 | 0.1 | 0.1 | 15 |
| (MPa) | | | | | | | | |
| Temp. (° C.) | 60 | 60 | 60 | 80 | 190 | 190 | 190 | 60 |
| Reaction | 6 | 6 | 6 | 1/3 | 2 | 2 | 2 | 2 |
| time (hr) | | | | | | | | |
| Number | 22,000 | 24,000 | 24,000 | 21,000 | 22,000 | 21,000 | 23,000 | 10,000 |
| average | | | | | | | | |
| molecular | | | | | | | | |
| weight (Mn) | | | | | | | | |
| Molecular | 1.7 | 1.4 | 1.3 | 1.6 | 1.8 | 1.7 | 1.6 | 1.9 |
| weight | | | | | | | | |
| distribution | | | | | | | | |
| (Mw/Mn) | | | | | | | | |
| Amount of | 300 | 800 | 900 | 800 | 6,800 | 6,000 | 5,000 | 200 |
| monomer | | | | | | | | |
| residues | | | | | | | | |
| (ppm) | | | | | | | | |
| Amount of | 1.5 | 1.6 | 1.3 | 1.2 | 2 | 2 | 2 | 1.2 |
| catalyst | | | | | | | | |
| residues | | | | | | | | |
| (wt %) | | | | | | | | |

TABLE 4

| | Ex. 1-18 | Ex. 1-19 | Ex. 1-20 |
|---|---|---|---|
| Catalyst | DBU | DBU | DMAP |
| Monomer | Lactide | Lactide | Lactide |
| | (L-form) | (L-form) | (D-form) |
| Initiator | Lauryl | Lauryl | Polylactic |
| | alcohol | alcohol | acid |
| | | | (L-form) |
| Amount of | 1 | 0.1 | 1.5 |
| initiator | | | |
| (mol %) | | | |
| Pressure | 15 | 15 | 15 |
| (MPa) | | | |
| Temperature | 60 | 60 | 100 |
| (° C.) | | | |
| Reaction | 2 | 2 | 2 |
| time (hr) | | | |
| Number | 15,000 | 110,000 | 28,000 |
| average | | | |
| molecular | | | |
| weight (Mn) | | | |
| Molecular | 1.8 | 1.9 | 1.9 |
| weight | | | |
| distribution | | | |
| (Mw/Mn) | | | |
| Amount of | 200 | 200 | 200 |
| monomer | | | |
| residues | | | |
| (ppm) | | | |
| Amount of | 0.8 | 0.1 or less | 0.1 or less |
| catalyst | | | |
| residues | | | |
| (wt %) | | | |

TABLE 5

| | | Comparative |
|---|---|---|
| | Example 1-1 | Example 1-4 |
| Glass transition | 45 | 38 |
| temperature (° C.) | | |
| Softening point | 108 | 99 |
| (° C.) | | |

### Example 2-1

A polymer product (polylactic acid) was obtained in the same manner as in Example 1-1, provided that the amount of the lauryl alcohol as the initiator was changed to 0.175 mol % relative to 100 mol % of the monomers. The obtained polymer product was formed into a film having a thickness of 100 μm by means of a general inflation film making machine at the temperature of 200° C. The obtained stretched film was subjected to the measurements of physical properties as the polymer product in the same manner as the above. The results are presented in Table 6.

### Examples 2-2 to 2-3

Stretch films of Examples 2-2 and 2-3 were each obtained in the same manner as in Example 2-1, provided that the amount of the initiator was changed to an amount depicted in a respective column of Examples 2-2 to 2-3 in Table 6. The obtained stretched film was subjected to the measurements of physical properties as the polymer product in the same manner as the above. The results are presented in Table 6.

### Examples 2-4 to 2-6

Stretch films of Examples 2-4 to 2-6 were each obtained in the same manner as in Example 2-1, provided that the reaction temperature was changed to temperature depicted in a respective column of Examples 2-4 to 2-6 in Table 6. The obtained stretched film was subjected to the measurements of physical properties as the polymer product in the same manner as the above. The results are presented in Table 6.

### Examples 2-7 to 2-8

Stretched films of Examples 2-7 to 2-8 were each obtained in the same manner as in Example 2-1, provided that the reaction pressure was changed to pressure depicted in a respective column of Examples 2-7 to 2-8 in Table 7. The obtained stretched film was subjected to the measurements of physical properties as the polymer product in the same manner as the above. The results are presented in Table 7.

### Examples 2-9 to 2-10

Stretched films of Examples 2-9 to 2-10 were each obtained in the same manner as in Example 2-1, provided that the reaction time and the reaction pressure were respectively changed to temperature and pressure depicted in respective columns of Examples 2-9 to 2-10 in Table 7. The obtained stretched film was subjected to the measurements of physical properties as the polymer product in the same manner as the above. The results are presented in Table 7.

### Examples 2-11 to 2-13

Stretched films of Examples 2-11 to 2-13 were each obtained in the same manner as in Example 2-1, provided that the monomer, catalyst, and reaction time were respectively changed to those depicted in respective columns of Examples 2-11 to 2-13 in Table 8. The obtained stretched film was subjected to the measurements of physical properties as the polymer product in the same manner as the above. The results are presented in Table 8.

### Comparative Example 2-1

A polymer product (polylactic acid) was obtained in the same manner as in Comparative Example 1-1, provided that the amount of the lauryl alcohol serving as the initiator was changed to 0.15 mol % relative to 100 mol % of the monomers. The obtained polymer product was formed into a film having a thickness of 100 μm by means of an inflation film forming machine at the temperature of 200° C. The obtained stretched film was subjected to the measurements of physical properties as the polymer product in the same manner as the above. The results are presented in Table 8. Note that, “Sn” in Table 8 denotes tin bis(2-ethylhexanoate).

### Comparative Examples 2-2 and 2-3

Stretched films of Comparative Examples 2-2 and 2-3 were each obtained in the same manner as in Comparative Example 2-1, provided that the monomer was changed to a monomer depicted in a respective column of Comparative Examples 2-2 and 2-3 in Table 8. The obtained stretched film was subjected to the measurements of physical properties as the polymer product in the same manner as the above. The results are presented in Table 8.

### Comparative Example 2-4

A polymer product (polylactic acid) was obtained in the same manner as in Comparative Example 1-4. The obtained polymer product was formed into a film having a thickness of 100 μm by means of a general inflation film forming machine at the temperature of 200° C. The obtained stretched film was subjected to the measurements of physical properties as the polymer product in the same manner as the above. The results are presented in Table 8.

When the number average molecular weight of the polymer contained in the stretched film is smaller than 12,000 (Comparative Example 2-4), the stretch film may have insufficient durability depending on use thereof. Moreover, it can be judged from the results presented in Tables 6 to 8, the stretched films of Examples are superior to the stretched films of Comparative Examples 1-1 to 1-3 in stability and safety concerned from an amount of metal atom residues and an amount of the ring-opening polymerizable monomer residues.

TABLE 6

| | Ex. 2-1 | Ex. 2-2 | Ex. 2-3 | Ex. 2-4 | Ex. 2-5 | Ex. 2-6 |
|---|---|---|---|---|---|---|
| Catalyst | DBU | DBU | DBU | DBU | DBU | DBU |
| Monomer | Lactide | Lactide | Lactide | Lactide | Lactide | Lactide |
| Initiator | Lauryl | Lauryl | Lauryl | Lauryl | Lauryl | Lauryl |
| | alcohol | alcohol | alcohol | alcohol | alcohol | alcohol |
| Amount of | 0.175 | 0.15 | 0.125 | 0.15 | 0.15 | 0.15 |
| initiator | | | | | | |
| (mol %) | | | | | | |
| Pressure | 15 | 15 | 15 | 15 | 15 | 15 |
| (MPa) | | | | | | |
| Temperature | 60 | 60 | 60 | 45 | 80 | 100 |
| (° C.) | | | | | | |
| Reaction | 2 | 2 | 2 | 2 | 2 | 2 |
| time (hr) | | | | | | |
| Number | 82,000 | 80,000 | 116,000 | 77,000 | 84,000 | 94,000 |
| average | | | | | | |
| molecular | | | | | | |
| weight (Mn) | | | | | | |
| Molecular | 1.4 | 1.5 | 1.4 | 1.6 | 1.5 | 1.6 |
| weight | | | | | | |
| distribution | | | | | | |
| (Mw/Mn) | | | | | | |
| Amount of | 100 | 500 | 700 | 600 | 500 | 300 |
| monomer | | | | | | |
| residues | | | | | | |
| (ppm) | | | | | | |
| Amount of | 1.5 | 1.3 | 1.4 | 1.4 | 1.3 | 1.1 |
| catalyst | | | | | | |
| residues | | | | | | |
| (wt %) | | | | | | |

TABLE 7

| | Ex. 2-7 | Ex. 2-8 | Ex. 2-9 | Ex. 2-10 |
|---|---|---|---|---|
| Catalyst | DBU | DBU | DBU | DBU |
| Monomer | Lactide | Lactide | Lactide | Lactide |
| Initiator | Lauryl | Lauryl | Lauryl | Lauryl |
| | alcohol | alcohol | alcohol | alcohol |
| Amount of | 0.15 | 0.15 | 0.15 | 0.15 |
| initiator | | | | |
| (mol %) | | | | |
| Pressure | 10 | 30 | 10 | 30 |
| (MPa) | | | | |
| Temperature | 60 | 60 | 60 | 60 |
| (° C.) | | | | |
| Reaction | 2 | 2 | 0.5 | 1 |
| time (hr) | | | | |
| Number | 77,000 | 90,000 | 67,000 | 80,000 |
| average | | | | |
| molecular | | | | |
| weight (Mn) | | | | |
| Molecular | 1.6 | 1.4 | 1.6 | 1.4 |
| weight | | | | |
| distribution | | | | |
| (Mw/Mn) | | | | |
| Amount of | 700 | 800 | 800 | 900 |
| monomer | | | | |
| residues | | | | |
| (ppm) | | | | |
| Amount of | 1.4 | 1.5 | 1.2 | 1.3 |
| catalyst | | | | |
| residues | | | | |
| (wt %) | | | | |

TABLE 8

| | | | | Comp. | Comp. | Comp. Ex. | Comp. |
|---|---|---|---|---|---|---|---|
| | Ex. 2-11 | Ex. 2-12 | Ex. 2-13 | Ex. 2-1 | Ex. 2-2 | 2-3 | Ex. 2-4 |
| Catalyst | DPG | TDB | DBU | Sn | Sn | Sn | DBU |
| Monomer | ε-capro | ε-capro | Ethylene | Lactide | ε-capro | Ethylene | Lactide |
| | lactone | lactone | carbonate | | lactone | carbonate | |
| Initiator | Lauryl | Lauryl | Lauryl | Lauryl | Lauryl | Lauryl | Lauryl |
| | alcohol | alcohol | alcohol | alcohol | alcohol | alcohol | alcohol |
| Amount of | 0.15 | 0.15 | 0.15 | 0.15 | 0.15 | 0.15 | 1.00 |
| initiator | | | | | | | |
| (mol %) | | | | | | | |
| Pressure | 10 | 10 | 10 | 0.1 | 0.1 | 0.1 | 15 |
| (MPa) | | | | | | | |
| Temperature | 60 | 60 | 60 | 190 | 190 | 190 | 60 |
| (° C.) | | | | | | | |
| Reaction | 6 | 6 | 6 | 2 | 2 | 2 | 2 |
| time (hr) | | | | | | | |
| Number | 74,000 | 80,000 | 80,000 | 74,000 | 70,000 | 77,000 | 10,000 |
| average | | | | | | | |
| molecular | | | | | | | |
| weight (Mn) | | | | | | | |
| Molecular | 1.7 | 1.4 | 1.3 | 1.8 | 1.7 | 1.6 | 1.9 |
| weight | | | | | | | |
| distribution | | | | | | | |
| (Mw/Mn) | | | | | | | |
| Amount of | 300 | 800 | 900 | 6,800 | 6,000 | 5,000 | 200 |
| monomer | | | | | | | |
| residues | | | | | | | |
| (ppm) | | | | | | | |
| Amount of | 1.5 | 1.6 | 1.3 | 2 | 2 | 2 | 1.2 |
| catalyst | | | | | | | |
| residues | | | | | | | |
| (wt %) | | | | | | | |

### Example 3-1

A polymer product (polylactic acid) was obtained in the same manner as in Example 1-1, provided that the amount of the lauryl alcohol serving as the initiator was changed to 0.1 mol % relative to 100 mol % of the monomers. The obtained polymer product was kneaded at 230° C. by means of a biaxial kneader (TME-18, manufactured by Toshiba Corporation) at a top edge of which a metering pump and a discharge nozzle were provided. The kneaded product was extruded into a shape of a strand, and immersed in water of 10° C., followed by cutting the strand by a cutter. The resultant was dried to thereby obtain pellets. The obtained pellets were subjected to the measurements of physical properties as the polymer product in the same manner as the above. The results are presented in Table 9.

### Example 3-2

Pellets were obtained in the same manner as in Example 3-1, provided that the amount of the initiator was changed to an amount depicted in a column of Example 3-2 in Table 9. The obtained pellets were subjected to the measurements of physical properties as the polymer product in the same manner as the above. The results are presented in Table 9.

### Examples 3-3 to 3-5

Pellets of Examples 3-3 to 3-5 were each obtained in the same manner as in Example 3-1, provided that the reaction temperature was changed to temperature depicted in a respective column of Examples 3-3 to 3-5 in Table 9. The obtained pellets were subjected to the measurements of physical properties as the polymer product. The results are presented in Table 9.

### Examples 3-6 to 3-8

Pellets of Examples 3-6 to 3-8 were each obtained in the same manner as in Example 3-1, provided that the reaction pressure was changed to pressure depicted in a respective column of Examples 3-6 to 3-8 in Table 9. The obtained pellets were subjected to the measurements of physical properties as the polymer product in the same manner as the above. The results are presented in Table 9.

### Examples 3-9 to 3-11

Pellets of Examples 3-9 to 3-11 were each obtained in the same manner as in Example 3-1, provided that the reaction time and reaction pressure were respectively changed to time and pressure depicted in respective columns of Examples 3-9 to 3-11 in Table 10. The obtained pellets were subjected to the measurements of physical properties as the polymer product in the same manner as the above. The results are presented in Table 10.

### Examples 3-12 to 3-14

Pellets of Examples 3-12 to 3-14 were each obtained in the same manner as in Example 3-1, provided that the monomer, catalyst, reaction pressure, and reaction time were respectively changed to those depicted in respective columns of Examples 3-12 to 3-14 in Table 10. The obtained pellets were subjected to the measurements of physical properties as the polymer product in the same manner as the above. The results are presented in Table 10.

### Example 3-15

By means of the polymerization reaction device illustrated in FIG. 3, a gear pump (metering feeder 2) was operated to feed the melted lactide in the tank 1 to the blending device 9 at a constant rate. A gear pump (metering feeder 4) was operated to feed lauryl alcohol serving as an initiator in the tank 3 to the blending device 9 at a constant rate so that the lauryl alcohol was in an amount of 0.1 mol % relative to the lactide. The temperature of the cylinder of the blending device 9 was 80° C. Carbonic acid gas was fed from a vent port (inlet 9a) to adjust the inner pressure of the system to 15 MPa. The metering pump 12 was operated to feed a polymerization catalyst, DBU, in the tank 11 to a raw material feed orifice (inlet 13b) so that the polymerization catalyst was in an amount of 0.1% by mass relative to the lactide. The temperature of the cylinder of the reaction vessel 13 was adjusted so that the temperature of the area adjacent to the raw material feeding section was 80° C., and the temperature at the edge section was 60° C. Moreover, the average retention time of the reaction product in this vessel was about 1,200 seconds. At the edge of the polymerization reaction device, a metering pump, and a discharge nozzle were attached, to extrude the reaction product into a shape form of a strand. The resultant was immersed in water of 10° C., followed by cutting by a cutter. The resultant was dried to thereby obtain pellets. The feeding rate of the polymer product by the metering pump 14 was 200 g/min. The obtained pellets were subjected to the measurements of physical properties as the polymer product in the same manner as the above. The results are presented in Table 10.

### Example 3-16

Pellets were obtained in the same manner as in Example 3-15, provided that the amount of the initiator was changed to an amount depicted in a respective column of Example 3-16 in Table 10. The obtained pellets were subjected to the measurements of physical properties as the polymer product in the same manner as the above. The results are presented in Table 10.

### Comparative Example 3-1

A polymer product (polylactic acid) was obtained in the same manner as in Comparative Example 1-1, provided that the amount of the lauryl alcohol serving as the initiator was changed to 0.1 mol % relative to 100 mol % of the monomers. The obtained polymer product was melt-kneaded at 230° C. by means of a biaxial kneader (TME-18, manufactured by Toshiba Corporation) at a top edge of which a metering pump and a discharge nozzle were provided. The kneaded product was extruded into a shape of a strand, and immersed in water of 10° C., followed by cutting the strand by a cutter. The resultant was dried to thereby obtain pellets. The obtained pellets were subjected to the measurements of physical properties as the polymer product in the same manner as the above. The results are presented in Table 11. Note that, “Sn” in Table 11 denotes tin bis(2-ethylhexanoate).

### Comparative Examples 3-2, 3-3, and 3-4

Pellets of Comparative Examples 3-2, 3-3, and 3-4 were each obtained in the same manner as in Comparative Example 3-1, provided that the initiator and monomer were respectively changed to an initiator and monomer depicted in respective columns of Comparative Examples 3-2, 3-3, and 3-4 in Table 11. The obtained pellets were subjected to the measurements of physical properties as the polymer product in the same manner as the above. The results are presented in Table 11.

### Comparative Example 3-5

A polymer product (polylactic acid) was obtained in the same manner as in Comparative Example 1-4. The obtained polymer product was kneaded at 230° C. by means of a biaxial kneader (TME-18, manufactured by Toshiba Corporation) at a top edge of which a metering pump and a discharge nozzle were provided. The kneaded product was extruded into a shape of a strand, and immersed in water of 10° C., followed by cutting the strand by a cutter. The resultant was dried to thereby obtain pellets. The obtained pellets were subjected to the measurements of physical properties as the polymer product in the same manner as the above. The results are presented in Table 11.

### [Production of Sheet]

The pellets obtained in each of Examples and Comparative Examples were used, and placed in a monoaxial extruder having a screw diameter of 90 mm (SE-90CV, manufactured by Toshiba Machine Co., Ltd.) equipped with a T-die having a width of 1,000 mm. The pellets were extruded at the extrusion temperature of 215° C., to make close contact with a cast roller of 40° C., to thereby obtain a sheet having a thickness of 350 μm.

### [Production of Sheet Molded Article]

Each sheet obtained in the production example of the sheet above was used to form a box-shaped container having a size of 250 mm in length, 200 mm in width, and 30 mm in depth using an aluminum mold and hot plate pressure forming machine (FKH-type Contact Heating Pressure Forming Machine, manufactured by Asano Kaboratories Co., Ltd.). During the molding, the temperature of the heated hot plate (heating and softening temperature) was 120° C., and the surface temperature of the mold was 117° C. The heating duration required for giving a shape was 10 seconds, the cooling duration was 5 seconds, and the shot cycle was 15 seconds. The molded semifinished product was pinched out by a die cutter using Thomson blade, to thereby obtain a sheet molded article.

### [Production of Injection Molded Article]

Each pellets obtained in the production example of the sheet above was used to form an inkection molded product having a size of 50 mm in length, 50 mm in width, and 5 mm in depth by means of a vertical type injection molding machine with screw (TKP-30-3HS, manufactured by Tabata Industrial Machinery Co., Ltd.) at the shaping temperature of 200° C.

### [Evaluation of Sheet, Sheet Molded Article, and Injection Molded Article]

The obtained sheet, sheet molded article, and injection molded article were evaluated based on the following evaluation criteria. The results of the evaluation are presented in Tables 9 to 11.

### —Evaluation of Sheet—

A sample having a size of 1,000 mm in length, and 1,000 mm in width was visually observed, and whether there was any fish-eye defect was confirmed and evaluated based on the following criteria.

### <Evaluation Criteria>

A: There was no fisheye defect

B: One to two fisheye defects were observed.

C: More than three fisheye defects were observed.

### —Evaluation of Sheet Molded Article—

One hundred samples of a sheet molded article were produced, and formability and appearance thereof were evaluated based on the following criteria.

### <Evaluation Criteria>

A: There was no problem in forming ability and appearance.

B: There were slight problems in forming ability and appearance (cracking occurred at least either in molding or in die cutting 1 to 9 samples, and the product was clouded under the visual observation).

C: There were obvious problems in forming ability and appearance (cracking occurred at least either in molding or in die cutting more than 10 samples, and the product was clearly clouded under the visual observation).

### —Evaluation of Injection Molded Article—

One hundred injection molded articles were produced, and evaluation was performed based on formability and appearance.

### <Evaluation Criteria>

A: There was no problem in forming ability and appearance.

B: There were slight problems in forming ability and appearance (burrs formed in 1 to 9 samples, and the product was slightly clouded under the visual observation).

C: There were obvious problems in forming ability and appearance (burrs significantly formed in more than 10 samples, and the product was clearly clouded under the visual observation).

It can be judged from the results presented in Tables 9 to 11 that the sheets or molded articles of Examples are superior over the sheets or molded articles Comparative Examples 3-1 to 3-5 in stability and safety concerned from catalyst residues and monomer residues, and forming ability. Moreover, when the number average molecular weight of the polymer contained in the sheet or molded article is smaller than 12,000 (Comparative Example 3-2, 3-5), the forming ability reduces.

TABLE 9

| | Ex. 3-1 | Ex. 3-2 | Ex. 3-3 | Ex. 3-4 | Ex. 3-5 | Ex. 3-6 | Ex. 3-7 | Ex. 3-8 |
|---|---|---|---|---|---|---|---|---|
| Catalyst | DBU | DBU | DBU | DBU | DBU | DBU | DBU | DBU |
| Monomer | Lactide | Lactide | Lactide | Lactide | Lactide | Lactide | Lactide | Lactide |
| Initiator | Lauryl | Lauryl | Lauryl | Lauryl | Lauryl | Lauryl | Lauryl | Lauryl |
| | alcohol | alcohol | alcohol | alcohol | alcohol | alcohol | alcohol | alcohol |
| Amount of | 0.100 | 0.075 | 0.075 | 0.075 | 0.075 | 0.075 | 0.075 | 0.075 |
| initiator | | | | | | | | |
| (mol %) | | | | | | | | |
| Pressure | 15 | 15 | 15 | 15 | 15 | 5 | 10 | 30 |
| (MPa) | | | | | | | | |
| Temp. (° C.) | 60 | 60 | 45 | 80 | 100 | 60 | 60 | 60 |
| Reaction | 2 | 2 | 2 | 2 | 2 | 2 | 2 | 2 |
| time (hr) | | | | | | | | |
| Number | 100,000 | 130,000 | 135,000 | 140,000 | 150,000 | 110,000 | 135,000 | 145,000 |
| average | | | | | | | | |
| molecular | | | | | | | | |
| weight | | | | | | | | |
| (Mn) | | | | | | | | |
| Molecular | 1.3 | 1.4 | 1.6 | 1.5 | 1.6 | 1.5 | 1.6 | 1.4 |
| weight | | | | | | | | |
| distribution | | | | | | | | |
| (Mw/Mn) | | | | | | | | |
| Amount of | 200 | 100 | 600 | 500 | 300 | 700 | 700 | 800 |
| monomer | | | | | | | | |
| residues | | | | | | | | |
| (ppm) | | | | | | | | |
| Amount of | 1.2 | 1.5 | 1.4 | 1.3 | 1.1 | 1.3 | 1.4 | 1.5 |
| catalyst | | | | | | | | |
| residues | | | | | | | | |
| (wt %) | | | | | | | | |
| Evaluation | A | A | A | A | A | A | A | A |
| of sheet | | | | | | | | |
| Evaluation | B | A | A | A | A | A | A | A |
| of sheet | | | | | | | | |
| molded | | | | | | | | |
| article | | | | | | | | |
| Evaluation | B | A | A | A | A | A | A | A |
| of injection | | | | | | | | |
| molded | | | | | | | | |
| article | | | | | | | | |

TABLE 10

| | Ex. 3-9 | Ex. 3-10 | Ex. 3-11 | Ex. 3-12 | Ex. 3-13 | Ex. 3-14 | Ex. 3-15 | Ex. 3-16 |
|---|---|---|---|---|---|---|---|---|
| Catalyst | DBU | DBU | DBU | DPG | TDB | DBU | DBU | DBU |
| Monomer | Lactide | Lactide | Lactide | ε-capro | ε-capro | Ethylene | Lactide | Lactide |
| | | | | lactone | lactone | carbonate | | |
| Initiator | Lauryl | Lauryl | Lauryl | Lauryl | Lauryl | Lauryl | Lauryl | Lauryl |
| | alcohol | alcohol | alcohol | alcohol | alcohol | alcohol | alcohol | alcohol |
| Amount of | 0.075 | 0.075 | 0.075 | 0.075 | 0.075 | 0.075 | 0.100 | 0.075 |
| initiator | | | | | | | | |
| (mol %) | | | | | | | | |
| Pressure | 5 | 10 | 30 | 10 | 10 | 10 | 15 | 15 |
| (MPa) | | | | | | | | |
| Temp. (° C.) | 60 | 60 | 60 | 60 | 60 | 60 | 80 | 80 |
| Reaction | 0.1 | 0.5 | 1 | 6 | 6 | 6 | 1/3 | 1/3 |
| time (hr) | | | | | | | | |
| Number | 98,000 | 100,000 | 135,000 | 120,000 | 135,000 | 135,000 | 105,000 | 130,000 |
| average | | | | | | | | |
| molecular | | | | | | | | |
| weight | | | | | | | | |
| (Mn) | | | | | | | | |
| Molecular | 1.5 | 1.6 | 1.4 | 1.7 | 1.4 | 1.3 | 1.6 | 1.6 |
| weight | | | | | | | | |
| distribution | | | | | | | | |
| (Mw/Mn) | | | | | | | | |
| Amount of | 800 | 800 | 800 | 300 | 800 | 900 | 800 | 800 |
| monomer | | | | | | | | |
| residues | | | | | | | | |
| (ppm) | | | | | | | | |
| Amount of | 1.4 | 1.2 | 1.3 | 1.5 | 1.6 | 1.3 | 1.2 | 1.2 |
| catalyst | | | | | | | | |
| residues | | | | | | | | |
| (wt %) | | | | | | | | |
| Evaluation | A | A | A | A | A | A | A | A |
| of sheet | | | | | | | | |
| Evaluation | B | A | A | A | A | A | B | A |
| of sheet | | | | | | | | |
| molded | | | | | | | | |
| article | | | | | | | | |
| Evaluation | B | A | A | A | A | A | B | A |
| of injection | | | | | | | | |
| molded | | | | | | | | |
| article | | | | | | | | |

TABLE 11

| | Comp. Ex. | Comp. Ex. | Comp. Ex. | Comp. Ex. | Comp. Ex. |
|---|---|---|---|---|---|
| | 3-1 | 3-2 | 3-3 | 3-4 | 3-5 |
| Catalyst | Sn | Sn | Sn | Sn | DBU |
| Monomer | Lactide | Lactide | ε-capro | Ethylene | Lactide |
| | | | lactone | carbonate | |
| Initiator | Lauryl | Lauryl | Lauryl | Lauryl | Lauryl |
| | alcohol | alcohol | alcohol | alcohol | alcohol |
| Amount of | 0.100 | 1.000 | 0.100 | 0.100 | 1.000 |
| initiator | | | | | |
| (mol %) | | | | | |
| Pressure | 0.1 | 0.1 | 0.1 | 0.1 | 15 |
| (MPa) | | | | | |
| Temp. (° C.) | 190 | 190 | 190 | 190 | 60 |
| Reaction | 2 | 2 | 2 | 2 | 2 |
| time (hr) | | | | | |
| Number | 115,000 | 10,000 | 110,000 | 120,000 | 10,000 |
| average | | | | | |
| molecular | | | | | |
| weight | | | | | |
| (Mn) | | | | | |
| Molecular | 1.8 | 1.8 | 1.7 | 1.6 | 1.9 |
| weight | | | | | |
| distribution | | | | | |
| (Mw/Mn) | | | | | |
| Amount of | 6,800 | 6,500 | 6,000 | 5,000 | 200 |
| monomer | | | | | |
| residues | | | | | |
| (ppm) | | | | | |
| Amount of | 2 | 2 | 2 | 2 | 1.2 |
| catalyst | | | | | |
| residues | | | | | |
| (wt %) | | | | | |
| Evaluation | C | C | C | C | C |
| of sheet | | | | | |
| Evaluation | C | C | C | C | C |
| of sheet | | | | | |
| molded article | | | | | |
| Evaluation | C | C | C | C | C |
| of injection | | | | | |
| molded article | | | | | |

### Example 4-11

A polymer product (polylactic acid) was obtained in the same manner as in Example 1-1, provided that the amount of the lauryl alcohol serving as the initiator was changed to 0.25 mol % relative to 100 mol % of the monomers. The obtained polymer product was spanned by means of a conventional simple melt spinning machine (Capilograph 1D PMD-C, Tokyo Seiki Seisaku-Sho, Ltd.), and the resultant was drawn by means of a hot air drawing machine, to thereby obtain monofilaments. The obtained monofilaments were subjected to the measurements of physical properties as the polymer product and the measurement of tensile strength in the manners described above. The results are presented in Table 12.

### Examples 4-2 to 4-3

Monofilaments of Examples 4-2 to 4-3 were each obtained in the same manner as in Example 4-1, provided that the amount of the initiator was changed to an amount depicted in a respective column of Examples 4-2 to 4-3 in Table 12. The obtained monofilaments were subjected to the measurements of physical properties as the polymer product and the measurement of tensile strength in the manners described above. The results are presented in Table 12.

### Examples 4-4 to 4-6

Monofilaments of Examples 4-4 to 4-6 were each obtained in the same manner as in Example 4-1, provided that the reaction temperature was changed to temperature depicted in a respective column of Examples 4-4 to 4-6 in Table 12. The obtained monofilaments were subjected to the measurements of physical properties as the polymer product and the measurement of tensile strength in the manners described above. The results are presented in Table 12.

### Examples 4-7 to 4-9

Monofilaments of Examples 4-7 to 4-9 were each obtained in the same manner as in Example 4-1, provided that the reaction pressure was changed to pressure depicted in a respective column of Examples 4-7 to 4-9 in Table 13. The obtained monofilaments were subjected to the measurements of physical properties as the polymer product and the measurement of tensile strength in the manners described above. The results are presented in Table 13.

### Examples 4-10 to 4-12

Monofilaments of Examples 4-10 to 4-12 were each obtained in the same manner as in Example 4-1, provided that the reaction time and reaction pressure were respectively changed to time and pressure depicted in respective columns of Examples 4-10 to 4-12 in Table 13. The obtained monofilaments were subjected to the measurements of physical properties as the polymer product and the measurement of tensile strength in the manners described above. The results are presented in Table 13.

### Examples 4-13 to 4-15

Monofilaments of Examples 4-13 to 4-15 were each obtained in the same manner as in Example 4-1, provided that the monomer, catalyst, reaction pressure and reaction time were respectively changed those depicted in respective columns of Examples 4-13 to 4-15 in Table 14. The obtained monofilaments were subjected to the measurements of physical properties as the polymer product and the measurement of tensile strength in the manners described above. The results are presented in Table 14.

### [Production of Nonwoven Fabric]

The polymer product produced in the same manner as in Example 4-2 was subjected to melt spinning, cooling, drawing, opening, stacking, and heat treatment by means of a spunbond nonwoven fabric manufacturing machine (manufactured by Shinwa Industrial Co., Ltd.) in accordance with conventional methods.

### Comparative Example 4-1

A polymer product (polylactic acid) was obtained in the same manner as in Comparative Example 1-1, provided that the amount of the lauryl alcohol serving as the initiator was changed to 0.1 mol % relative to 100 mol % of the monomers. The obtained polymer product was spanned by means of a conventional simple melt spinning machine (Capilograph 1D PMD-C, Tokyo Seiki Seisaku-Sho, Ltd.), and the resultant was drawn by means of a hot air drawing machine, to thereby obtain monofilaments. The obtained monofilaments were subjected to the measurements of physical properties as the polymer product and the measurement of tensile strength in the manners described above. The results are presented in Table 14. Note that, “Sn” in Table 14 denotes tin bis(2-ethylhexanoate).

### Comparative Examples 4-2 and 4-3

Monofilaments of Comparative Examples 4-2 and 4-3 were each obtained in the same manner as in Comparative Example 4-1, provided that the monomer was changed to a monomer depicted in a respective column of Comparative Examples 4-2 and 4-3 in Table 14. The obtained monofilaments were subjected to the measurements of physical properties as the polymer product and the measurement of tensile strength in the manners described above. The results are presented in Table 14.

### Example 4-16

In a 100 mL-pressure resistant vessel, 90 parts by mass of lactide of L-lactic acid, 10 parts by mass of lactide of D-lactic acid, 0.25 mol % of lauryl alcohol serving as an initiator, relative to 100 mol % of the monomers, and 2.0 mol % of 1,8-diazabicyclo[5.4.0]undec-7-ene (DBU) serving as an organic catalyst were measured, and added so that the mass of the entire system became 50 g. A difference to Example 4-1 is the timing for adding the organic catalyst. Thereafter, the pressure resistant vessel was charged with supercritical carbon dioxide (60° C., 15 MPa). After the internal temperature of the system reached 60° C., the mixture in the pressure resistant vessel was allowed to react for 2 hours. After the completion of the reaction, the reaction product was gradually returned to the ambient temperature and pressure, and the compressive fluid and a polymer product were discharged from the valve 28 while reducing the pressure. As a result, carbon dioxide was vaporized, to thereby obtain a polymer product (polylactic acid). The obtained polymer product was spanned by means of a conventional simple melt spinning machine (Capilograph 1D PMD-C, Tokyo Seiki Seisaku-Sho, Ltd.), and the resultant was drawn by means of a hot air drawing machine, to thereby obtain monofilaments. The obtained monofilaments were subjected to the measurements of physical properties as the polymer product and the measurement of tensile strength in the manners described above. The results are presented in Table 14.

### Comparative Example 4-5

Monofilaments were obtained in the same manner as in Example 4-16, provided that the amount of the initiator was changed to an amount depicted in a column of Comparative Example 4-5 in Table 14. The obtained monofilaments were subjected to the measurements of physical properties as the polymer product and the measurement of tensile strength in the manners described above. The results are presented in Table 14.

The tensile strength of the monofilaments is correlative with a molecular weight of the polymer. When the number average molecular weight of the polymer contained in the fibers is less than 12,000 (Comparative Example 4-5), the durability of the fibers may be insufficient depending on use thereof. Moreover, it can be easily judged from the results presented in Tables 12 to 14 that the fibers of Examples are superior to the fibers of Comparative Examples 4-1 to 4-3 in stability and safety of the fibers concerned from an amount of metal atom residues and an amount of the ring-opening polymerizable monomer residues.

TABLE 12

| | Ex. 4-1 | Ex. 4-2 | Ex. 4-3 | Ex. 4-4 | Ex. 4.5 | Ex. 4-6 |
|---|---|---|---|---|---|---|
| Catalyst | DBU | DBU | DBU | DBU | DBU | DBU |
| Monomer | Lactide | Lactide | Lactide | Lactide | Lactide | Lactide |
| Initiator | Lauryl | Lauryl | Lauryl | Lauryl | Lauryl | Lauryl |
| | alcohol | alcohol | alcohol | alcohol | alcohol | alcohol |
| Amount of | 0.25 | 0.1 | 0.075 | 0.1 | 0.1 | 0.1 |
| initiator | | | | | | |
| (mol %) | | | | | | |
| Pressure | 15 | 15 | 15 | 15 | 15 | 15 |
| (MPa) | | | | | | |
| Temperature | 60 | 60 | 60 | 45 | 80 | 100 |
| (° C.) | | | | | | |
| Reaction time | 2 | 2 | 2 | 2 | 2 | 2 |
| (hr) | | | | | | |
| Number | 58,000 | 150,000 | 190,000 | 115,000 | 125,000 | 140,000 |
| average | | | | | | |
| molecular | | | | | | |
| weight (Mn) | | | | | | |
| Molecular | 1.4 | 1.3 | 1.5 | 1.6 | 1.5 | 1.6 |
| weight | | | | | | |
| distribution | | | | | | |
| (Mw/Mn) | | | | | | |
| Amount of | 700 | 200 | 500 | 600 | 500 | 300 |
| monomer | | | | | | |
| residues | | | | | | |
| (ppm) | | | | | | |
| Amount of | 1.4 | 1.2 | 1.3 | 1.4 | 1.3 | 1.1 |
| catalyst | | | | | | |
| residues | | | | | | |
| (wt %) | | | | | | |
| Monofilament | 2.5 | 2.8 | 3.0 | 2.8 | 2.8 | 2.9 |
| tensile | | | | | | |
| strength | | | | | | |
| (cN/dtex) | | | | | | |

TABLE 13

| | | | | Ex. | Ex. | Ex. |
|---|---|---|---|---|---|---|
| | Ex. 4-7 | Ex. 4-8 | Ex. 4-9 | 4-10 | 4-11 | 4-12 |
| Catalyst | DBU | DBU | DBU | DBU | DBU | DBU |
| Monomer | Lactide | Lactide | Lactide | Lactide | Lactide | Lactide |
| Initiator | Lauryl | Lauryl | Lauryl | Lauryl | Lauryl | Lauryl |
| | alcohol | alcohol | alcohol | alcohol | alcohol | alcohol |
| Amount of | 0.1 | 0.1 | 0.1 | 0.1 | 0.1 | 0.1 |
| initiator | | | | | | |
| (mol %) | | | | | | |
| Pressure | 5 | 15 | 30 | 5 | 10 | 30 |
| (MPa) | | | | | | |
| Temperature | 60 | 60 | 60 | 60 | 60 | 60 |
| (° C.) | | | | | | |
| Reaction time | 2 | 2 | 2 | 0.1 | 0.5 | 1 |
| (hr) | | | | | | |
| Number | 90,000 | 115,000 | 135,000 | 80,000 | 100,000 | 120,000 |
| average | | | | | | |
| molecular | | | | | | |
| weight (Mn) | | | | | | |
| Molecular | 1.5 | 1.6 | 1.4 | 1.5 | 1.6 | 1.4 |
| weight | | | | | | |
| distribution | | | | | | |
| (Mw/Mn) | | | | | | |
| Amount of | 700 | 700 | 800 | 800 | 800 | 900 |
| monomer | | | | | | |
| residues | | | | | | |
| (ppm) | | | | | | |
| Amount of | 1.3 | 1.4 | 1.5 | 1.4 | 1.2 | 1.3 |
| catalyst | | | | | | |
| residues | | | | | | |
| (wt %) | | | | | | |
| Monofilament | 2.6 | 2.8 | 2.8 | 2.6 | 2.7 | 2.7 |
| tensile | | | | | | |
| strength | | | | | | |
| (cN/dtex) | | | | | | |

TABLE 14

| | | Ex. | | Comp. | Comp. | Comp. | Comp. | Comp. |
|---|---|---|---|---|---|---|---|---|
| | Ex. 4-13 | 4-14 | Ex. 4-15 | Ex. 4-1 | Ex. 4-2 | Ex. 4-3 | Ex. 4-4 | Ex. 4-5 |
| Catalyst | DPG | TDB | DBU | Sn | Sn | Sn | DBU | DBU |
| Monomer | ε-capro | ε-capro | Ethylene | Lactide | ε-capro | Ethylene | Lactide | Lactide |
| | lactone | lactone | carbonate | | lactone | carbonate | | |
| Initiator | Lauryl | Lauryl | Lauryl | Lauryl | Lauryl | Lauryl | Lauryl | Lauryl |
| | alcohol | alcohol | alcohol | alcohol | alcohol | alcohol | alcohol | alcohol |
| Amount of | 0.1 | 0.1 | 0.1 | 0.1 | 0.1 | 0.1 | 0.25 | 1.00 |
| initiator | | | | | | | | |
| (mol %) | | | | | | | | |
| Pressure | 10 | 10 | 10 | 0.1 | 0.1 | 0.1 | 15 | 15 |
| (MPa) | | | | | | | | |
| Temp. (° C.) | 60 | 60 | 60 | 190 | 190 | 190 | 60 | 60 |
| Reaction time | 6 | 6 | 6 | 2 | 2 | 2 | 2 | 2 |
| (hr) | | | | | | | | |
| Number | 110,000 | 120,000 | 120,000 | 110,000 | 105,000 | 115,000 | 40,000 | 10,000 |
| average | | | | | | | | |
| molecular | | | | | | | | |
| weight (Mn) | | | | | | | | |
| Molecular | 1.7 | 1.4 | 1.3 | 1.8 | 1.7 | 1.6 | 1.9 | 1.9 |
| weight | | | | | | | | |
| distribution | | | | | | | | |
| (Mw/Mn) | | | | | | | | |
| Amount of | 300 | 800 | 900 | 6,800 | 6,000 | 5,000 | 20,000 | 800 |
| monomer | | | | | | | | |
| residues | | | | | | | | |
| (ppm) | | | | | | | | |
| Amount of | 1.5 | 1.6 | 1.3 | 2 | 2 | 2 | 1.2 | 1.3 |
| catalyst | | | | | | | | |
| residues | | | | | | | | |
| (wt %) | | | | | | | | |
| Monofilament | 2.8 | 2.7 | 2.7 | 2.8 | 2.7 | 2.8 | 2.5 | 2.3 |
| tensile | | | | | | | | |
| strength | | | | | | | | |
| (cN/dtex) | | | | | | | | |

### Example 5-1

In a 100 mL-reaction vessel 27, 90 parts by mass of lactide of L-lactic acid, 10 parts by mass of lactide of D-lactic acid, and 1.00 mol % of lauryl alcohol serving as an initiator relative to 100 mol % of the monomers were measured and added so that the mass of the entire system became 50 g. After heating the mixture in the reaction vessel to 110° C., the reaction vessel was charged with supercritical carbon dioxide (60° C., 15 MPa) by the metering pump 22, followed by dissolving the raw materials with stirring for 10 minutes. After adjusting the internal temperature of the system to 60° C., the path of the compressive fluid was switch to the path passing through an addition pot 25. As a result, an organic catalyst (1,8-diazabicyclo[5.4.0]undec-7-ene (DBU), 2.0 mol %), which had been stored in the addition pot 25, was pushed out from the addition pot 25 to the reaction vessel 27 at the set pressure higher, by 1 MPa, than the internal pressure of the reaction vessel 27, whereby adding the organic catalyst from the addition pot 25 to the reaction vessel 27. Thereafter, the resulting mixture was allowed to react for 2 hours. After the completion of the reaction, a polymer product was discharged from a valve 28 while reducing the pressure. As a result, carbon dioxide was vaporized, to thereby yield the polymer product (polylactic acid). The obtained polymer product was pulverized by means of a counter jet mill (manufactured by Hosokawa Micron Corporation), to thereby obtain particles having the volume average particle diameter of 6 μm. The obtained particles were subjected to the measurements of the physical properties as the polymer product in the aforementioned manners. The results are presented in Table 15.

### Examples 5-2 to 5-4

Polymer products of Examples 5-2 to 5-4 were each obtained in the same manner as in Example 5-1, provided that an amount of the initiator was changed as depicted in a respective column of Examples 5-2 to 5-4 in Table 15. Particles were formed from the obtained polymer product in the same manner as in Example 5-1. The obtained particles were subjected to the measurements of the physical properties as the polymer product in the aforementioned manners. The results are presented in Table 15.

### Examples 5-5 to 5-7

Polymer products of Examples 5-5 to 5-7 were each obtained in the same manner as in Example 5-1, provided that the reaction temperature was changed as depicted in a respective column of Examples 5-5 to 5-7 in Table 15. Particles were formed from the obtained polymer product in the same manner as in Example 5-1. The obtained particles were subjected to the measurements of the physical properties as the polymer product in the aforementioned manners. The results are presented in Table 15.

### Examples 5-8 to 5-10

Polymer products of Examples 5-8 to 5-10 were each produced in the same manner as in Example 5-1, provided that the reaction pressure was changed as depicted in a respective column of Examples 5-8 to 5-10 in Table 16. Particles were formed from the obtained polymer product in the same manner as in Example 5-1. The obtained particles were subjected to the measurements of the physical properties as the polymer product in the aforementioned manners. The results are presented in Table 16.

### Examples 5-11 to 5-13

Polymer products of Examples 5-11 to 5-13 were each obtained in the same manner as in Example 5-1, provided that the reaction time and pressure were changed as depicted in respective columns of Examples 5-11 to 5-13 in Table 16. Particles were formed from the obtained polymer product in the same manner as in Example 5-1. The obtained particles were subjected to the measurements of the physical properties as the polymer product in the aforementioned manners. The results are presented in Table 16.

### Examples 5-14 to 5-16

Polymer products of Examples 5-14 to 5-16 were each obtained in the same manner as in Examples 5-1, provided that the monomer, catalyst, reaction pressure and reaction time were changed as depicted in respective column of Examples 5-14 to 5-16 in Table 17. The obtained polymer product was formed into foam by vaporizing the carbon dioxide present inside. Moreover, particles were formed from the obtained polymer product in the same manner as in Example 5-1. The obtained particles were subjected to the measurements of the physical properties as the polymer product in the aforementioned manners. The results are presented in Table 17.

### Examples 5-17 to 5-19

Polymer products of Examples 5-17 to 5-19 were each obtained in the same manner as in Example 5-1, provided that an amount of the catalyst was changed as depicted in a respective column of Examples 5-17 to 5-19. The obtained polymer product was formed into foam by vaporizing the carbon dioxide present inside. Moreover, particles were formed from the obtained polymer product in the same manner as in Example 5-1. The obtained particles were subjected to the measurements of the physical properties as the polymer product in the aforementioned manners. The results are presented in Table 18.

### Comparative Example 5-1

In a flask, 90 parts by mass of lactide of L-lactic acid, 10 parts by mass of lactide of D-lactic acid, and 0.5 mol % of lauryl alcohol serving as an initiator relative to 100 mol % of the monomers were measured and added under the atmospheric pressure (0.1 MPa) so that the mass of the entire system became 50 g. Next, the mixture was heated with nitrogen purging, and after confirming the entire system became homogenous, 2 mol % of tin bis(2-ethylhexanoate) serving as a catalyst was added, followed by carrying out a polymerization reaction. During the polymerization reaction, the internal temperature of the system was controlled so as not to exceed 190° C. After reacting for 2 hours, unreacted lactide was removed under the reduced pressure, and a polymer product (polylactic acid) in the flask was taken out. The obtained polymer product was pulverized by means of a counter jet mill (manufactured by Hosokawa Micron Corporation), to thereby obtain particles. The obtained particles were subjected to the measurements of the physical properties as the polymer product in the aforementioned manners. The results are presented in Table 18. Note that, “Sn” in Table 18 denotes tin bis(2-ethylhexanoate).

### Comparative Examples 5-2 to 5-3

Particles of Comparative Examples 5-2 to 5-3 were each obtained in the same manner as in Comparative Example 5-1, provided that the monomer was changed as depicted in a respective column of Comparative Examples 5-2 to 5-3 in Table 18. The obtained particles were subjected to the measurements of the physical properties as the polymer product in the aforementioned manners. The results are presented in Table 18.

TABLE 15

| | Ex. 5-1 | Ex. 5-2 | Ex. 5-3 | Ex. 5-4 | Ex. 5-5 | Ex. 5-6 | Ex. 5-7 |
|---|---|---|---|---|---|---|---|
| Catalyst | DBU | DBU | DBU | DBU | DBU | DBU | DBU |
| Monomer | Lactide | Lactide | Lactide | Lactide | Lactide | Lactide | Lactide |
| Initiator | Lauryl | Lauryl | Lauryl | Lauryl | Lauryl | Lauryl | Lauryl |
| | alcohol | alcohol | alcohol | alcohol | alcohol | alcohol | alcohol |
| Amount of | 1.00 | 0.75 | 0.50 | 0.25 | 1.00 | 1.00 | 1.00 |
| initiator | | | | | | | |
| (mol %) | | | | | | | |
| Pressure | 15 | 15 | 15 | 15 | 15 | 15 | 15 |
| (MPa) | | | | | | | |
| Temperature | 60 | 60 | 60 | 60 | 45 | 80 | 100 |
| (° C.) | | | | | | | |
| Reaction time | 2 | 2 | 2 | 2 | 2 | 2 | 2 |
| (hr) | | | | | | | |
| Number | 15,000 | 18,000 | 24,000 | 58,000 | 14,000 | 15,000 | 12,000 |
| average | | | | | | | |
| molecular | | | | | | | |
| weight (Mn) | | | | | | | |
| Molecular | 1.3 | 1.4 | 1.5 | 1.4 | 1.6 | 1.5 | 1.6 |
| weight | | | | | | | |
| distribution | | | | | | | |
| (Mw/Mn) | | | | | | | |
| Amount of | 200 | 100 | 500 | 700 | 600 | 500 | 300 |
| monomer | | | | | | | |
| residues | | | | | | | |
| (ppm) | | | | | | | |
| Amount of | 1.2 | 1.5 | 1.3 | 1.4 | 1.4 | 1.3 | 1.1 |
| catalyst | | | | | | | |
| residues | | | | | | | |
| (wt %) | | | | | | | |
| YI value | 4.8 | 4.5 | 3.8 | 4.8 | 4.4 | 4.2 | 4.3 |

TABLE 16

| | | | Ex. | Ex. | Ex. | Ex. |
|---|---|---|---|---|---|---|
| | Ex. 5-8 | Ex. 5-9 | 5-10 | 5-11 | 5-12 | 5-13 |
| Catalyst | DBU | DBU | DBU | DBU | DBU | DBU |
| Monomer | Lactide | Lactide | Lactide | Lactide | Lactide | Lactide |
| Initiator | Lauryl | Lauryl | Lauryl | Lauryl | Lauryl | Lauryl |
| | alcohol | alcohol | alcohol | alcohol | alcohol | alcohol |
| Amount of | 1.00 | 1.00 | 1.00 | 1.00 | 1.00 | 1.00 |
| initiator | | | | | | |
| (mol %) | | | | | | |
| Pressure | 5 | 10 | 30 | 5 | 10 | 30 |
| (MPa) | | | | | | |
| Temperature | 60 | 60 | 60 | 60 | 60 | 60 |
| (° C.) | | | | | | |
| Reaction time | 2 | 2 | 2 | 0.1 | 0.5 | 1 |
| (hr) | | | | | | |
| Number | 13,000 | 14,000 | 12,000 | 12,000 | 12,000 | 14,000 |
| average | | | | | | |
| molecular | | | | | | |
| weight (Mn) | | | | | | |
| Molecular | 1.5 | 1.6 | 1.4 | 1.5 | 1.6 | 1.4 |
| weight | | | | | | |
| distribution | | | | | | |
| (Mw/Mn) | | | | | | |
| Amount of | 700 | 700 | 800 | 800 | 800 | 900 |
| monomer | | | | | | |
| residues | | | | | | |
| (ppm) | | | | | | |
| Amount of | 1.3 | 1.4 | 1.5 | 1.4 | 1.2 | 1.3 |
| catalyst | | | | | | |
| residues | | | | | | |
| (wt %) | | | | | | |
| YI value | 4.5 | 4.7 | 4.3 | 4.1 | 3.7 | 3.6 |

TABLE 17

| | Ex. 5-14 | Ex. 5-15 | Ex. 5-16 |
|---|---|---|---|
| Catalyst | DPG | TDB | DBU |
| Monomer | ε-capro lactone | ε-capro lactone | Ethylene |
| | | | carbonate |
| Initiator | Lauryl alcohol | Lauryl alcohol | Lauryl alcohol |
| Amount of initiator | 0.50 | 0.50 | 0.50 |
| (mol %) | | | |
| Pressure (MPa) | 10 | 10 | 10 |
| Temperature (° C.) | 60 | 60 | 60 |
| Reaction time (hr) | 10 | 10 | 10 |
| Number average | 22,000 | 20,000 | 14,000 |
| molecular weight (Mn) | | | |
| Molecular weight | 1.7 | 1.4 | 1.3 |
| distribution (Mw/Mn) | | | |
| Amount of monomer | 300 | 800 | 900 |
| residues (ppm) | | | |
| Amount of catalyst | 1.5 | 1.6 | 1.3 |
| residues (wt %) | | | |
| YI value | 4.6 | 4.3 | 4.8 |

TABLE 18

| | Ex. | Ex. | Ex. | Comp. | Comp. | Comp. |
|---|---|---|---|---|---|---|
| | 5-17 | 5-18 | 5-19 | Ex. 5-1 | Ex. 5-2 | Ex. 5-3 |
| Catalyst | DBU | DBU | DBU | Sn | Sn | Sn |
| Amount of | 0.2 | 1.0 | 1.5 | 2.0 | 2.0 | 2.0 |
| catalyst | | | | | | |
| (mol %)0.2 | | | | | | |
| Monomer | Lactide | Lactide | Lactide | Lactide | ε-capro | Ethylene |
| | | | | | lactone | carbonate |
| Initiator | Lauryl | Lauryl | Lauryl | Lauryl | Lauryl | Lauryl |
| | alcohol | alcohol | alcohol | alcohol | alcohol | alcohol |
| Amount of | 1.00 | 1.00 | 1.00 | 0.50 | 0.50 | 0.50 |
| initiator | | | | | | |
| (mol %) | | | | | | |
| Pressure | 15 | 15 | 15 | 0.1 | 0.1 | 0.1 |
| (MPa) | | | | | | |
| Temperature | 60 | 60 | 60 | 190 | 190 | 190 |
| (° C.) | | | | | | |
| Reaction | 2 | 2 | 2 | 2 | 2 | 2 |
| time (hr) | | | | | | |
| Number | 13,000 | 12,000 | 14,000 | 10,000 | 10,000 | 10,000 |
| average | | | | | | |
| molecular | | | | | | |
| weight (Mn) | | | | | | |
| Molecular | 1.6 | 1.7 | 1.3 | 1.8 | 1.7 | 1.6 |
| weight | | | | | | |
| distribution | | | | | | |
| (Mw/Mn) | | | | | | |
| Amount of | 99 | 100 | 99 | 6,800 | 6,000 | 5,000 |
| monomer | | | | | | |
| residues | | | | | | |
| (ppm) | | | | | | |
| Amount of | 1.4 | 1.5 | 1.6 | 2.0 | 2.0 | 2.0 |
| catalyst | | | | | | |
| residues | | | | | | |
| (wt %) | | | | | | |
| YI value | 0.8 | 1.5 | 2.3 | 10.0 | 9.5 | 8.5 |

The embodiments of the present invention are as follows:

<1> A polymer product, wherein the polymer product is substantially free from an organic solvent and a metal atom, and has a number average molecular weight of 12,000 or greater.
<2> The polymer product according to <1>, wherein the polymer product contains ring-opening polymerizable monomer residues in an amount of 1,000 parts per million by mass or smaller.
<3> The polymer product according to any of <1> or <2>, wherein the polymer product has a value Mw/Mn of 1.2 to 2.5, where Mw represents a weight average molecular weight of the polymer product and Mn represents the number average molecular weight thereof and the value Mw/Mn is a value obtained by dividing the Mw with the Mn.
<4> The polymer product according to any one of <1> to <3>, wherein the polymer product has a carbonyl bond.
<5> The polymer product according to <4>, wherein the polymer product has either an ester bond or a carbonate bond.
<6> The polymer product according to <5>, wherein the polymer product is polyester.
<7> The polymer product according to <5>, wherein the polymer product is polycarbonate.
<8> The polymer product according to any one of <1> to <7>, wherein the polymer product is obtained by the method comprising:

allowing a ring-opening polymerizable monomer to undergo ring-opening polymerization with a compressive fluid and an organic catalyst free from a metal atom.

<9> The polymer product according to <8>, wherein the polymer product contains residues of the organic catalyst in an amount of less than 2% by mass.
<10> The polymer product according to any one of <8> to <9>, wherein the organic catalyst contains 1,4-diazabicyclo-[2.2.2]octane, 1,8-diazabicyclo[5.4.0]undec-7-ene, 1,5,7-triazabicyclo[4.4.0]dec-5-ene, diphenyl guanidine, N,N-dimethyl-4-aminopyridine, 4-pyrrolidinopyridine, or 1,3-di-tert-butylimidazol-2-ylidene.
<11> The polymer product according to any one of <1> to <10>, wherein the polymer product is a copolymer containing two or more polymer segments.
<12> The polymer product according to any one of <1> to <11>, wherein the polymer product is a stereo complex.
<13> The polymer product according to any one of <1> to <12>, wherein the polymer product is white in color.
<14> A polymer compact, containing:

the polymer product as defined in any one of <1> to <13>.

<15> The polymer compact according to <14>, wherein the polymer product is polylactic acid.
<16> A polymer compact for medical use, containing the polymer product as defined in any one of <1> to <13>, wherein the polymer compact is biodegradable.
<17> A toner containing the polymer product as defined in any one of <1> to <13>.
<18> A polymer composition containing the polymer product as defined in any one of <1> to <13>.

### REFERENCE SIGNS LIST

1 tank
2 metering feeder
3 tank
4 metering feeder
5 tank
6 metering pump
7 tank
8 metering pump
9 blending device
10 liquid transfer pump
11 tank
12 metering pump
13 reaction vessel
14 metering pump
15 discharge nozzle
21 tank
22 metering pump
23 valve
24 valve
25 addition pot
26 valve
27 pressure vessel
28 valve
30 pipe
100 polymerization reaction device
125 addition pot
130 pipe
200 polymerization reaction device
300 polymerization reaction device

1. A polymer product, wherein
the polymer product is substantially free from an organic solvent and a metal atom, and has a number average molecular weight of 12,000 or greater.

2. The polymer product according to claim 1, comprising ring-opening polymerizable monomer residues in an amount of 1,000 parts per million by mass or smaller.

3. The polymer product according to claim 1, wherein the polymer product has a value Mw/Mn of 1.2 to 2.5, where Mw represents a weight average molecular weight of the polymer product and Mn represents the number average molecular weight thereof.

4. The polymer product according to claim 1, comprising a carbonyl bond.

5. The polymer product according to claim 4, further comprising either an ester bond or a carbonate bond.

6. The polymer product according to claim 5, wherein the polymer product is polyester.

7. The polymer product according to claim 5, wherein the polymer product is polycarbonate.

8. The polymer product according to claim 1, wherein the polymer product is obtained by a process comprising:
subjecting a ring-opening polymerizable monomer to a ring-opening polymerization with a compressive fluid and an organic catalyst free from a metal atom.

9. The polymer product according to claim 8, comprising residues of the organic catalyst in an amount of less than 2% by mass.

10. The polymer product according to claim 8, wherein the organic catalyst comprises 1,4-diazabicyclo-[2.2.2]octane, 1,8-diazabicyclo[5.4.0]undec-7-ene, 1,5,7-triazabicyclo[4.4.0]dec-5-ene, diphenyl guanidine, N,N-dimethyl-4-aminopyridine, 4-pyrrolidinopyridine, or 1,3-di-tert-butylimidazol-2-ylidene.

11. The polymer product according to claim 1, wherein the polymer product is a copolymer comprising two or more polymer segments.

12. The polymer product according to claim 1, wherein the polymer product is a stereo complex.

13. The polymer product according to claim 1, wherein the polymer product is white in color.

14. A polymer compact, comprising:
a polymer product substantially free from an organic solvent and a metal atom and having a number average molecular weight of 12,000 or greater.

15. The polymer compact according to claim 14, wherein the polymer product is polylactic acid.

16. The polymer compact according to claim 14, wherein the polymer compact is biodegradable, and is suitable for medical use.

17. A toner, comprising
a polymer product substantially free from an organic solvent and a metal atom, and having a number average molecular weight of 12,000 or greater.
